(19) United States
(12) Patent Application Publication
(10) Pub. No.: US 2026/0175870 A1
(43) Pub. Date: Jun. 25, 2026

(54) Traffic Signal State Detection

(71) Applicant: Aurora Operations, Inc., Pittsburgh, PA (US)

(72) Inventors: Nemanja Djuric, Pittsburgh, PA (US); Theodore Klerman Lewitt, Santa Cruz, CA (US); Jason L. Owens, Indianola, PA (US)

(21) Appl. No.: 19/176,359

(22) Filed: Apr. 11, 2025

Related U.S. Application Data
(60) Provisional application No. 63/737,118, filed on Dec. 20, 2024.

(51) Int. Cl. B60W 60/00; B60W 50/00; G08G 1/01

(52) U.S. Cl. CPC B60W 60/001; B60W 50/00; G08G 1/0125; B60W 2420/403

(57) ABSTRACT

An example computer-implemented method includes: obtaining environment data descriptive of one or more traffic signal devices of a traffic control node in an environment of an autonomous vehicle; generating a control node graph based on the environment data including vertices respective to representations of the traffic signal devices and edges indicative of relationships between the representations of the traffic signal devices; providing the control node graph as input to a control node graph processing model operable to reduce the control node graph to a distilled representation of the control node graph encoding information about a state of the traffic control node; based on receipt of the control node graph as input, generating an output based on the control node graph processing model; generating a motion plan based on the output from the control node graph processing model; and controlling the autonomous vehicle based on the motion plan.

### PRIORITY CLAIM

This application claims priority to and the benefit of U.S. Patent Application No. 63/737,118 filed Dec. 20, 2024, which is incorporated herein by reference in its entirety.

### FIELD

The present disclosure relates generally to the operation of an autonomous vehicle including detection and recognition of traffic signal states.

### BACKGROUND

Vehicles, including autonomous vehicles, can receive data based on the state of the environment around the vehicle including the state of objects in the environment. This data can be used by the autonomous vehicle to perform various functions related to the particular state of those objects. Further, as the vehicle travels through the environment the set of objects in the environment and the state of those objects can also change. Accordingly, there exists a need for a computing system that more effectively determines the state of objects in an environment.

### SUMMARY

Aspects and advantages of implementations of the present disclosure will be set forth in part in the following description, or may be learned from the description, or may be learned through practice of the implementations.

Example aspects of the present disclosure are directed to systems and methods for improved traffic signal state detection. For instance, using the technology described herein, a computing system (e.g., of an autonomous vehicle) can determine control node state data associated with a traffic control node.

One approach for traffic control node state classification utilizes two separate processes including a classifier, which includes a graphics processing unit (GPU)-based model that outputs single region of interest (RoI) classifications but lacks conceptualization of spatiotemporal properties, and a filter, which is a central processing unit (CPU)-based linear model that lacks spatial conceptualization but is capable of aggregating classifications over time. Furthermore, three separate datasets can be required to train the GPU-based classifier, the CPU-based filter, and/or the perception system as a whole. Because of the high demand for CPU-based resources on autonomous vehicle systems, it can be desirable to build a single, GPU-based model that consumes perception data such as representations of sensor data relevant to traffic signaling devices, spatial layout information (e.g., in the form of adjacency), and/or embedding history as input and produces control node state output. This can provide several benefits including reduced training datasets (e.g., a single dataset), fewer labels (e.g., high-level control node labels vs low-level per-camera/per-device labels), improved availability of information to the system, simplified module/framework architecture, reduction in latency from messaging between multiple components, enablement of end-to-end training regimes, and/or improved classification performance.

Therefore, it can be advantageous to provide improved systems and methods for traffic signal state estimation, especially for autonomous vehicle applications. In particular, according to example aspects of the present disclosure, a computing system (e.g., an autonomous vehicle computing system) can generate state data illustrative of a state of a traffic control node by a control node graph processing model. The control node graph processing model can be any suitable type of model (e.g., a machine-learned model). As examples, the control node graph processing model can be or can include, but is not limited to, a graph neural network (GNN), graph attention network (GAT), or a graph convolutional network (GCN).

The control node graph processing model can be trained end-to-end to enable the control node graph processing model to reduce a control node graph to a distilled representation of the control node graph encoding information about the state of the traffic control node. The distilled representation of the control node graph can be a computer-generated (e.g., not necessarily human-readable) representation of the control node graph that is generated by condensing input data including the control node graph itself or a derivative representation of the control node graph to a reduced form. The distilled representation of the control node graph can, for example, require fewer computing resources to store, transmit, and/or process than the control node graph. Furthermore, the control node graph processing model can be enabled through end-to-end training to preserve information available in the control node graph that is relevant for detecting states of traffic control nodes in the distilled representation of the control node graph. This information may be distilled such that an attribute of the control node graph can correspond to an attribute of the distilled representation of the control node graph, although this correspondence may not necessarily be immediately observable from human observation of the distilled representation of the control node graph. One example distilled representation of the control node graph can be an embedding or an encoding generated by processing the control node graph with the control node graph processing model.

Representations from multiple data channels (e.g., corresponding to multiple sensor devices or data sources) can be used to produce multiple vertices and/or an aggregate vertex for a traffic signal device. For example, in some implementations, an autonomous vehicle can include a plurality of sensor devices (e.g., cameras), where each sensor device can produce representations of a common traffic signal device in channels of environment data (e.g., sensor device data) from each sensor device. The representations can each correspond to a vertex in the control node graph, and may be grouped by edges indicating that the representations depict a common traffic signal device. As another example, in some implementations, the representations from each data channel can be combined into a single aggregate vertex that includes or corresponds to the representations from each data channel. Fusing representations from the plurality of channels can provide for improved consistency of outputs as the autonomous vehicle navigates throughout the environment. For example, the output can be robust to changes in availability or priority of information from each channel.

As one example, an autonomous vehicle can include a plurality of cameras having varying resolutions to capture image data of the environment of the autonomous vehicle from differing perspectives. For example, the autonomous vehicle may include a wide-angle camera configured to capture image data of a larger portion of the environment of the autonomous vehicle and a focused-view camera configured to capture image data of a relatively smaller portion of the environment of the autonomous vehicle. The wide-angle camera may be used, for example, to capture information about actors that are relatively closer to the autonomous vehicle (e.g., due to the lower resolution), whereas the focused-view camera may be used to capture more detailed information about a relatively greater number of actors that are farther from the autonomous vehicle, due to the increased resolution providing an improved capability to make out details of actors farther from the vehicle.

Because of variations in positions of the cameras about the autonomous vehicle, each camera may be able to provide slightly different information about a particular region in the environment. For example, if the environment data corresponding to a traffic signal device in one camera is occluded by an object (e.g., foliage), another camera may have a view of the traffic signal device. As another example, as the autonomous vehicle approaches an intersection, the focused-view camera may have a view of a first traffic signal device (e.g., ahead of the autonomous vehicle), but may be unable to capture image data of a second traffic signal device in the intersection (e.g., in an adjacent lane, such as a turn lane), whereas the wide-angle camera may be able to capture image data of the second traffic signal device even when close to the intersection. By including representations of the traffic signal devices from the multiple cameras described above in a control node graph, the computing system can obtain an improved understanding of the environment of the autonomous vehicle and/or can provide improved scene consistency as an autonomous vehicle navigates throughout the environment. For example, the computing system can reason about the second traffic signal device even when it is occluded in one of the cameras. Furthermore, the output from the control node graph processing model can be consistent as traffic signal devices come into and out of view of the multiple cameras.

For example, in an aspect, the present disclosure provides a computer-implemented method. The computer-implemented method includes obtaining environment data descriptive of one or more traffic signal devices of a traffic control node in an environment of an autonomous vehicle. The computer-implemented method includes generating a control node graph based on the environment data descriptive of the one or more traffic signal devices, the control node graph including vertices respective to representations of the traffic signal devices in the data and edges indicative of relationships between the representations of the traffic signal devices in the environment data descriptive of the one or more traffic signal devices. The computer-implemented method includes providing the control node graph as input to a control node graph processing model operable to reduce the control node graph to a distilled representation of the control node graph encoding information about a state of the traffic control node. The computer-implemented method includes, based on receipt of the control node graph as input, generating an output based on the control node graph processing model. The computer-implemented method includes generating a motion plan based on the output from the control node graph processing model. The computer implemented method includes controlling the autonomous vehicle based on the motion plan.

For example, in an aspect, the present disclosure provides an autonomous vehicle computing system. The autonomous vehicle computing system includes one or more processors and one or more non-transitory, computer-readable media storing instructions that, when implemented, cause the one or more processors to perform operations. The operations include obtaining environment data descriptive of one or more traffic signal devices of a traffic control node in an environment of an autonomous vehicle. The operations include generating a control node graph based on the environment data descriptive of the one or more traffic signal devices, the control node graph including vertices respective to representations of the traffic signal devices in the data and edges indicative of relationships between the representations of the traffic signal devices in the environment data descriptive of the one or more traffic signal devices. The operations include providing the control node graph as input to a control node graph processing model operable to reduce the control node graph to a distilled representation of the control node graph encoding information about a state of the traffic control node. The operations include, based on receipt of the control node graph as input, generating an output based on the control node graph processing model. The operations include generating a motion plan based on the output from the control node graph processing model. The operations include controlling the autonomous vehicle based on the motion plan.

For example, in an aspect, the present disclosure provides an autonomous vehicle. The autonomous vehicle includes one or more processors and one or more non-transitory, computer-readable media storing instructions that, when implemented, cause the one or more processors to perform operations. The operations include obtaining environment data descriptive of one or more traffic signal devices of a traffic control node in an environment of an autonomous vehicle. The operations include generating a control node graph based on the environment data descriptive of the one or more traffic signal devices, the control node graph including vertices respective to representations of the traffic signal devices in the data and edges indicative of relationships between the representations of the traffic signal devices in the environment data descriptive of the one or more traffic signal devices. The operations include providing the control node graph as input to a control node graph processing model operable to reduce the control node graph to a distilled representation of the control node graph encoding information about a state of the traffic control node. The operations include, based on receipt of the control node graph as input, generating an output based on the control node graph processing model. The operations include generating a motion plan based on the output from the control node graph processing model. The operations include controlling the autonomous vehicle based on the motion plan.

Other example aspects of the present disclosure are directed to other systems, methods, vehicles, apparatuses, tangible non-transitory computer-readable media, and devices for performing functions described herein. These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 is a block diagram of an example operational scenario, according to some implementations of the present disclosure;

FIG. 2 is a block diagram of an example system, according to some implementations of the present disclosure;

FIG. 3A is a representation of an example operational environment, according to some implementations of the present disclosure;

FIG. 3B is a representation of an example map of an operational environment, according to some implementations of the present disclosure;

FIG. 3C is a representation of an example operational environment, according to some implementations of the present disclosure;

FIG. 3D is a representation of an example map of an operational environment, according to some implementations of the present disclosure;

FIG. 4 is a block diagram of a traffic signal state detection system, according to some implementations of the present disclosure;

FIG. 5 is a block diagram of a traffic signal state detection system, according to some implementations of the present disclosure;

FIG. 6 depicts an example traffic signal device, according to some implementations of the present disclosure;

FIG. 7 depicts an example traffic control node, according to some implementations of the present disclosure;

FIGS. 8-13 depict example control node graphs, according to some implementations of the present disclosure;

FIG. 14 is a flowchart of example methods, according to some implementations of the present disclosure; and

FIG. 15 is a block diagram of an example computing system, according to some implementations of the present disclosure.

### DETAILED DESCRIPTION

The following describes the technology of this disclosure within the context of an autonomous vehicle for example purposes only. As described herein, the technology described herein is not limited to an autonomous vehicle and may be implemented for or within other autonomous platforms and other computing systems.

The present disclosure provides systems and methods for improved traffic signal state detection. For instance, using the technology described herein, a computing system (e.g., of an autonomous vehicle) can determine control node state data associated with a traffic control node. As used herein, a “traffic control node” refers to a set of one or more traffic signal devices configured to control traffic in an incoming direction of travel at an intersection or other traffic control point. The traffic control node can include and/or control one or more traffic signal devices. As used herein, a “traffic signal device” can refer to a device configured to indicate the authorized movement of vehicles, pedestrians, and/or other actors within an intersection or along a direction of travel. A traffic signal device may be, for example, a device otherwise referred to as a “traffic light,” “stoplight,” “pedestrian hybrid beacon” or “PHB”, “high-intensity activated crosswalk beacon” or “HAWK beacon”, or other suitable indicator device.

The traffic signal device may generally follow an understood convention for signaling the authorized flow of traffic. For example, the traffic signal device may include one or more bulb elements that are selectively lit to indicate whether actors are authorized to proceed or not. The colors, shapes, patterns, and/or arrangement of the bulb elements can convey information relating to the authorized movement of actors. For example, a traffic signal device having a lit red bulb element is conventionally understood to indicate that actors are not to proceed whereas a traffic signal device having a lit green bulb element is conventionally understood to indicate that actors are authorized to proceed (subject to other considerations such as whether an intersection is clear or safe to enter).

Furthermore, traffic signal devices associated with a plurality of traffic control nodes may coordinate to control the movement of traffic across an area such as an intersection. For instance, a four-way intersection can include four traffic control nodes respective to the four directions of travel at the intersection. The traffic control nodes can coordinate to allow entry to the intersection in non-intersecting incoming directions of travel. For example, a first traffic control node at a first direction and a second traffic control node at an opposing second direction can coordinate to signal that traffic heading straight from both directions of travel may be contemporaneously authorized to enter the intersection. As another example, a first traffic control node may signal that left turns towards a direction of an adjacent second traffic control node are allowed. The adjacent second traffic control node may coordinate with the first traffic control node to contemporaneously signal that right turns towards the direction of the first traffic control node are allowed.

To facilitate operation, many traffic control nodes can progress through a series of states, where a state of the traffic control node indicates which bulb elements will be illuminated at each traffic signal device of the traffic control node. It can be advantageous for an autonomous vehicle to ascertain information about the state of the traffic control node. For instance, an autonomous vehicle with knowledge of traffic control node state can reliably generate motion plans that account for upcoming changes in the traffic control node state. However, the state of a traffic control node may be related to not only the illuminated bulb elements of a single traffic signal element (e.g., associated with a current lane of the autonomous vehicle), but also may potentially be related to the illuminated bulb elements of other traffic signal devices for an autonomous vehicle traveling in the same incoming direction (e.g., traffic signal devices associated with other lanes in the same incoming direction of travel). For example, if a traffic control node includes a first traffic signal device (e.g., controlling traffic proceeding straight past the traffic control node) and a second traffic signal device (e.g., controlling traffic turning left past the traffic control node), the state of the traffic control node can be dependent on the illuminated bulb elements of both the first traffic signal device and the second traffic signal device. Therefore, determining the state of the traffic control node can be more complicated than simply classifying a traffic signal device based on color of an illuminated bulb element.

Furthermore, the state of the traffic control node can often correspond to the states of other, related traffic control nodes. In some cases, the states across multiple traffic control nodes may be coordinated such that a determination can be made based on a view of all signaling devices of a single traffic control node. However, in some cases, it can be difficult to precisely determine the internal state of the related traffic control nodes of the intersection. Furthermore, when in view of the traffic signal devices of one traffic control node, the traffic signal devices of related traffic control nodes may not necessarily be visible, which can complicate efforts to determine the internal state of a traffic control node. As one example, at a given instance in time, a traffic control node with an illuminated red bulb element may be in either a first state when a red bulb element is illuminated at a traffic signal device of an opposite traffic control node or a second state when a green arrow bulb element is illuminated at a traffic signal device of the opposite traffic control node. Without viewing the traffic signal devices of the opposite traffic control node at these locations having related traffic control nodes, it can be difficult or impossible to precisely determine the internal state of the traffic control node.

Despite this ambiguity, the internal state of a traffic control node can be an important variable in planning motion of an autonomous vehicle. As one example, in the case of a traffic control node displaying a red bulb element in an outgoing direction of travel, the duration which actors must wait before proceeding if the traffic control node is in a first state, can be significantly shorter than the duration in a visually-similar second state. For instance, the first state can be that the opposing traffic control node is signaling that traffic may proceed in a direction toward the traffic control node and may also turn against the traffic control node and where the next state is to allow traffic to proceed from the traffic control node. The second state can be that both the traffic control node and the opposing traffic control node are stopping traffic to allow cross-directional traffic to cross the intersection. An autonomous vehicle may, for example, elect to stop at the intersection and wait to proceed if the traffic control node is in the first state. However, the autonomous vehicle may elect to pursue an alternate route around the intersection if, for example, the traffic control node is in the second state and if the time to take that alternate route is lower than the time the autonomous vehicle would likely wait to proceed when the traffic control node is in the second state.

The computing system can generate a control node graph that represents the traffic control node based on environment data depicting the traffic control node. For instance, the control node graph can include vertices corresponding to one or more representations of each traffic signal device of the traffic control node in the environment data and/or edges between the vertices defining relationships between the representations. For example, in some implementations, an edge between a first vertex and a second vertex can indicate that the first vertex and the second vertex share a same scene or a same time instance, depict a common traffic signal device, depict adjacent traffic signal devices, or otherwise share some relationship.

The representations of traffic signal devices in the environment data can be any suitable representation. As one example, in some implementations, the representations of traffic signal devices can be environment data within portions of initial environment data associated with the traffic signal devices. For example, in some implementations, a perception system or perception model can receive initial environment data. For instance, the initial environment data can be or can include a scan or sweep of a field of view of a sensor device, a stored scan or image, or other relatively larger data that depicts the traffic signal devices and may depict other elements that are not the traffic signal devices. The perception system can generate RoI data associated with each traffic signal device in the initial environment data. The RoI data can include, for example, coordinates, bounding boxes, or other information that is descriptive of a portion of the environment data respectively associated with a traffic signal device. The perception system or another system can extract the environment data within the portions of the initial environment data respectively associated with the one or more traffic signal devices from the initial environment data based on the data descriptive of the portions of the initial environment data. For example, if the initial environment data is a scan, sweep, or image, extracting the environment data can include cropping the scan, sweep, or image to include only data bounded by or within the region of interest.

As another example, in some implementations, the representations of traffic signal devices in the environment can be or can include a transformed or distilled representation of the environment data corresponding to the traffic signal devices. For example, in some implementations, the environment data corresponding to a particular traffic signal device may be extracted for a region of interest as described above. The extracted environment data can be used to generate a distilled representation of the environment data corresponding to the particular traffic signal device. As one example, the distilled representation can be an embedding. For instance, the control node graph processing model or another suitable model can process the extracted environment data for a region of interest corresponding to a particular traffic signal device and output the distilled representation of the extracted environment data within the region of interest.

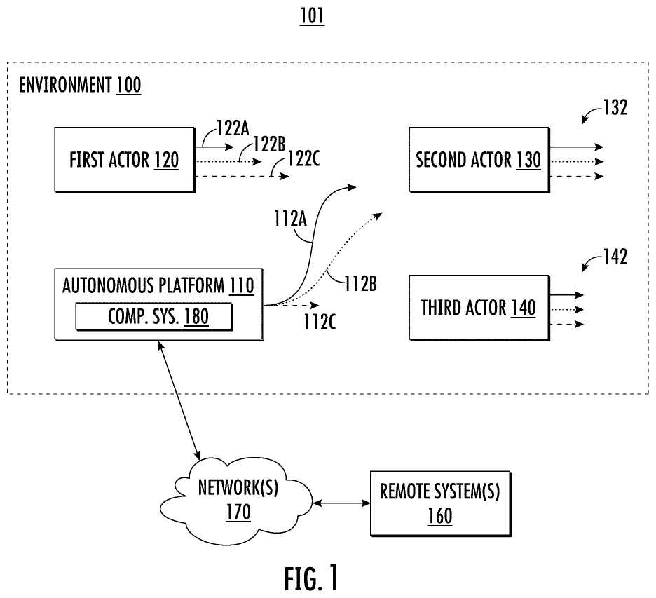

With more particular reference to FIGS. 1-15, example embodiments of the present disclosure are discussed in further detail. FIG. 1 is a block diagram 101 of an example operational scenario according to example implementations of the present disclosure. In the example operational scenario, an environment 100 contains an autonomous platform 110 and a number of objects, including first actor 120, second actor 130, and third actor 140. In the example operational scenario, the autonomous platform 110 may move through the environment 100 and interact with the object(s) that are located within the environment 100 (e.g., first actor 120, second actor 130, third actor 140). The autonomous platform 110 may optionally be configured to communicate with remote system(s) 160 through network(s) 170.

The environment 100 may be or include an indoor environment (e.g., within one or more facilities.) or an outdoor environment. An indoor environment, for example, may be an environment enclosed by a structure such as a building (e.g., a service depot, maintenance location, manufacturing facility). An outdoor environment, for example, may be one or more areas in the outside world such as, for example, one or more rural areas (e.g., with one or more rural travel ways), one or more urban areas (e.g., with one or more city travel ways, highways), one or more suburban areas (e.g., with one or more suburban travel ways), or other outdoor environments.

The autonomous platform 110 may be any type of platform configured to operate within the environment 100. For example, the autonomous platform 110 may be a vehicle configured to autonomously perceive and operate within the environment 100. The vehicles may be a ground-based autonomous vehicle such as, for example, an autonomous car, truck, van, or other vehicle type. The autonomous platform 110 may be an autonomous vehicle that may control, be connected to, or be otherwise associated with implements, attachments, and/or accessories for transporting people or cargo. This may include, for example, an autonomous tractor optionally coupled to a cargo trailer. Additionally or alternatively, the autonomous platform 110 may be any other type of vehicle such as one or more aerial vehicles, water-based vehicles, space-based vehicles, or other ground-based vehicles.

The autonomous platform 110 may be configured to communicate with the remote system(s) 160. For instance, the remote system(s) 160 may communicate with the autonomous platform 110 for assistance (e.g., navigation assistance, situation response assistance), control (e.g., fleet management, remote operation), maintenance (e.g., updates, monitoring), or other local or remote tasks. In some implementations, the remote system(s) 160 may provide data indicating tasks that the autonomous platform 110 should perform. For example, as further described herein, the remote system(s) 160 may provide data indicating that the autonomous platform 110 is to perform a trip/service such as a user transportation trip/service, delivery trip/service (e.g., for cargo, freight, items), or other service.

The autonomous platform 110 may communicate with the remote system(s) 160 using the network(s) 170. The network(s) 170 may facilitate the transmission of signals (e.g., electronic signals) or data (e.g., data from a computing device) and may include any combination of various wired (e.g., twisted pair cable) or wireless communication mechanisms (e.g., cellular, wireless, satellite, microwave, radio frequency) or any desired network topology (or topologies). For example, the network(s) 170 may include a local area network (e.g., intranet), a wide area network (e.g., the Internet), a wireless LAN network (e.g., through Wi-Fi), a cellular network, a SATCOM network, a VHF network, a HF network, a WiMAX based network, or any other suitable communications network (or combination thereof) for transmitting data to or from the autonomous platform 110.

As shown for example in FIG. 1, the environment 100 may include one or more objects. The object(s) may be objects not in motion or not predicted to move (“static objects”) or object(s) in motion or predicted to be in motion (“dynamic objects” or “actors”). In some implementations, the environment 100 may include any number of actor(s) such as, for example, one or more pedestrians, animals, vehicles, trailers, or other actor types. An object may include one or more portions. For example, a truck including a tractor pulling a trailer may be identified as a single object, with multiple portions: a first portion (e.g., tractor) and a second portion (e.g., trailer). In some implementations, the portions may be identified as separate objects. For example, a tractor may be identified as a first object and a trailer (being pulled by the tractor) may be identified as a separate, second object. In another example, an open door of a vehicle may be identified as a separate object from the vehicle or as an extension of the vehicle, as further described herein.

The actor(s) may move within the environment according to one or more actor trajectories. For instance, the first actor 120 may move along any one of the first actor trajectories 122A-C, the second actor 130 may move along any one of the second actor trajectories 132, and the third actor 140 may move along any one of the third actor trajectories 142. In an embodiment, the actor(s) may include extensions which extend from the main volume of the object. These extensions may be considered as the autonomous platform 110 traverses the environment 100.

As further described herein, the autonomous platform 110 may utilize its autonomy system(s) to detect these actors (and their movement), their extensions, and plan its motion to navigate through the environment 100 according to one or more platform trajectories 112A-C. The autonomous platform 110 may include onboard computing system(s) 180. The onboard computing system(s) 180 may include one or more processors and one or more memory devices. The one or more memory devices may store instructions executable by the one or more processors to cause the one or more processors to perform operations or functions associated with the autonomous platform 110, including implementing its autonomy system(s).

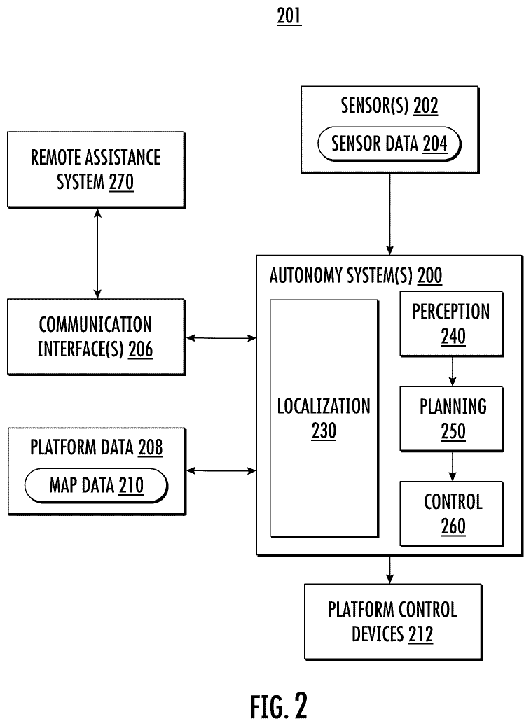

FIG. 2 is a block diagram 201 of an example autonomy system 200 for an autonomous platform, according to some implementations of the present disclosure. In some implementations, the autonomy system 200 may be implemented by a computing system of the autonomous platform (e.g., the onboard computing system(s) 180 of the autonomous platform 110). The autonomy system 200 may operate to obtain inputs from sensor(s) 202 or other input devices. In some implementations, the autonomy system 200 may additionally obtain platform data 208 (e.g., map data 210) from local or remote storage. The autonomy system 200 may generate control outputs for controlling the autonomous platform (e.g., through platform control devices 212) based on sensor data 204, map data 210, or other data.

The autonomy system 200 may include different subsystems for performing various autonomy operations. The subsystems may include a localization system 230, a perception system 240, a planning system 250, and a control system 260. The localization system 230 may determine the location of the autonomous platform within its environment; the perception system 240 may detect, classify, and track objects in the environment; the planning system 250 may determine a trajectory for the autonomous platform; and the control system 260 may translate the trajectory into vehicle controls for controlling the autonomous platform. The autonomy system 200 may be implemented by one or more onboard computing system(s). The subsystems may include one or more processors and one or more memory devices. The one or more memory devices may store instructions executable by the one or more processors to cause the one or more processors to perform operations or functions associated with the subsystems. The computing resources of the autonomy system 200 may be shared among its subsystems, or a subsystem may have a set of dedicated computing resources.

In some implementations, the autonomy system 200 may be implemented for or by an autonomous vehicle (e.g., a ground-based autonomous vehicle). The autonomy system 200 may perform various processing techniques on inputs (e.g., the sensor data 204, the map data 210) to perceive and understand the vehicle's surrounding environment and generate an appropriate set of control outputs to implement a vehicle motion plan (e.g., including one or more trajectories) for traversing the vehicle's surrounding environment (e.g., environment 100 of FIG. 1). In some implementations, an autonomous vehicle implementing the autonomy system 200 may drive, navigate, or operate, with minimal or no interaction from a human operator (e.g., driver, pilot).

In some implementations, the autonomous platform may be configured to operate in a plurality of operating modes. For instance, the autonomous platform may be configured to operate in a fully autonomous operating mode in which the autonomous platform is controllable without user input (e.g., may drive and navigate with no input from a human operator present in the autonomous vehicle or remote from the autonomous vehicle). The autonomous platform may operate in a semi-autonomous operating mode in which the autonomous platform may operate with some input from a human operator present in the autonomous platform (or a human operator that is remote from the autonomous platform). In some implementations, the autonomous platform may enter into a manual operating mode in which the autonomous platform is fully controllable by a human operator (e.g., human driver) and may be prohibited or disabled (e.g., temporary, permanently) from performing autonomous navigation (e.g., autonomous driving). The autonomous platform may be configured to operate in other modes such as, for example, park or sleep modes (e.g., for use between tasks such as waiting to provide a trip/service, recharging). In some implementations, the autonomous platform may implement vehicle operating assistance technology (e.g., collision mitigation system, power assist steering), for example, to help assist the human operator of the autonomous platform (e.g., while in a manual mode).

The autonomy system 200 may be located onboard (e.g., on or within) an autonomous platform and may be configured to operate the autonomous platform in various environments. The environment may be a real-world environment or a simulated environment. In some implementations, one or more simulation computing devices may simulate one or more of: the sensors 202, the sensor data 204, communication interface(s) 206, the platform data 208, or the platform control devices 212 for simulating operation of the autonomy system 200.

In some implementations, the autonomy system 200 may communicate with one or more networks or other systems with the communication interface(s) 206. The communication interface(s) 206 may include any suitable components for interfacing with one or more network(s) (e.g., the network(s) 170 of FIG. 1), including, for example, transmitters, receivers, ports, controllers, antennas, or other suitable components that may help facilitate communication. In some implementations, the communication interface(s) 206 may include a plurality of components (e.g., antennas, transmitters, receivers) that allow it to implement and utilize various communication techniques (e.g., multiple-input, multiple-output (MIMO) technology).

In some implementations, the autonomy system 200 may use the communication interface(s) 206 to communicate with one or more computing devices that are remote from the autonomous platform (e.g., the remote system(s) 160) over one or more network(s) (e.g., the network(s) 170). For instance, in some examples, one or more inputs, data, or functionalities of the autonomy system 200 may be supplemented or substituted by a remote system communicating over the communication interface(s) 206. For instance, in some implementations, the map data 210 may be downloaded over a network to a remote system using the communication interface(s) 206. In some examples, one or more of the localization system 230, the perception system 240, the planning system 250, or the control system 260 may be updated, influenced, nudged, or communicated with, by a remote system for assistance, maintenance, situational response override, management, or other purposes.

The sensor(s) 202 may be located onboard the autonomous platform. In some implementations, the sensor(s) 202 may include one or more types of sensor(s). For instance, one or more sensors may include image capturing device(s) (e.g., visible spectrum cameras, infrared cameras). Additionally or alternatively, the sensor(s) 202 may include one or more depth capturing device(s). For example, the sensor(s) 202 may include one or more Light Detection and Ranging (LIDAR) sensor(s) or Radio Detection and Ranging (RADAR) sensor(s). The sensor(s) 202 may be configured to generate point data descriptive of at least a portion of a three-hundred-and-sixty-degree view of the surrounding environment. The point data may be point cloud data (e.g., three-dimensional LIDAR point cloud data, RADAR point cloud data). In some implementations, one or more of the sensor(s) 202 for capturing depth information may be fixed to a rotational device in order to rotate the sensor(s) 202 about an axis. The sensor(s) 202 may be rotated about the axis while capturing data in interval sector packets descriptive of different portions of a three-hundred-and-sixty-degree view of a surrounding environment of the autonomous platform. In some implementations, one or more of the sensor(s) 202 for capturing depth information may be solid state.

The sensor(s) 202 may be configured to capture the sensor data 204 indicating or otherwise being associated with at least a portion of the environment of the autonomous platform. The sensor data 204 may include image data (e.g., 2D camera data, video data), RADAR data, LIDAR data (e.g., 3D point cloud data), audio data, or other types of data. In some implementations, the autonomy system 200 may obtain input from additional types of sensors, such as inertial measurement units (IMUs), altimeters, inclinometers, odometry devices, location or positioning devices (e.g., GPS, compass), wheel encoders, or other types of sensors. In some implementations, the autonomy system 200 may obtain sensor data 204 associated with particular component(s) or system(s) of an autonomous platform. This sensor data 204 may indicate, for example, wheel speed, component temperatures, steering angle, cargo or passenger status. In some implementations, the autonomy system 200 may obtain sensor data 204 associated with ambient conditions, such as environmental or weather conditions. In some implementations, the sensor data 204 may include multi-modal sensor data. The multi-modal sensor data may be obtained by at least two different types of sensor(s) (e.g., of the sensors 202) and may indicate static object(s) within an environment of the autonomous platform. The multi-modal sensor data may include at least two types of sensor data (e.g., camera and LIDAR data). In some implementations, the autonomous platform may utilize the sensor data 204 for sensors that are remote from (e.g., offboard) the autonomous platform. This may include, for example, sensor data 204 captured by a different autonomous platform.

The autonomy system 200 may obtain the map data 210 associated with an environment in which the autonomous platform was, is, or will be located. The map data 210 may provide information about an environment or a geographic area. For example, the map data 210 may provide information regarding the identity and location of different travel ways (e.g., roadways), travel way segments (e.g., road segments), buildings, or other items or objects (e.g., lampposts, crosswalks, curbs); the location and directions of boundaries or boundary markings (e.g., the location and direction of traffic lanes, parking lanes, turning lanes, bicycle lanes, other lanes); traffic control data (e.g., the location and instructions of signage, traffic lights, other traffic control devices); obstruction information (e.g., temporary or permanent blockages); event data (e.g., road closures/traffic rule alterations due to parades, concerts, sporting events); nominal vehicle path data (e.g., indicating an ideal vehicle path such as along the center of a certain lane); or any other map data that provides information that assists an autonomous platform in understanding its surrounding environment and its relationship thereto. In some implementations, the map data 210 may include high-definition map information. Additionally or alternatively, the map data 210 may include sparse map data (e.g., lane graphs). In some implementations, the sensor data 204 may be fused with or used to update the map data 210 in online or offline.

The autonomy system 200 may include the localization system 230, which may provide an autonomous platform with an understanding of its location and orientation in an environment. In some examples, the localization system 230 may support one or more other subsystems of the autonomy system 200, such as by providing a unified local reference frame for performing, e.g., perception operations, planning operations, or control operations.

In some implementations, the localization system 230 may determine a current position of the autonomous platform. A current position may include a global position (e.g., respecting a georeferenced anchor) or relative position (e.g., respecting objects in the environment). The localization system 230 may generally include or interface with any device or circuitry for analyzing a position or change in position of an autonomous platform (e.g., autonomous ground-based vehicle). For example, the localization system 230 may determine position by using one or more of: inertial sensors (e.g., inertial measurement unit(s)), a satellite positioning system, radio receivers, networking devices (e.g., based on IP address), triangulation or proximity to network access points or other network components (e.g., cellular towers, Wi-Fi access points), or other suitable techniques. The position of the autonomous platform may be used by various subsystems of the autonomy system 200 or provided to a remote computing system (e.g., using the communication interface(s) 206).

In some implementations, the localization system 230 may register relative positions of elements of a surrounding environment of an autonomous platform with recorded positions in the map data 210. For instance, the localization system 230 may process the sensor data 204 (e.g., LIDAR data, RADAR data, camera data) for aligning or otherwise registering to a map of the surrounding environment (e.g., from the map data 210) to understand the position of the autonomous platform 110 within that environment. Accordingly, in some implementations, the autonomous platform 110 may identify its position within the surrounding environment (e.g., across six axes) based on a search over the map data 210. In some implementations, given an initial location, the localization system 230 may update the location of the autonomous platform 110 with incremental re-alignment based on recorded or estimated deviations from the initial location. In some implementations, a position may be registered within the map data 210.

The map data 210 may include a large volume of data subdivided into geographic tiles, such that a desired region of a map stored in the map data 210 may be reconstructed from one or more tiles. For instance, a plurality of tiles selected from the map data 210 may be stitched together by the autonomy system 200 based on a position obtained by the localization system 230 (e.g., a number of tiles selected in the vicinity of the position).

In some implementations, the localization system 230 may determine positions (e.g., relative or absolute) of one or more attachments or accessories for an autonomous platform 110. For instance, an autonomous platform 110 may be associated with a cargo platform, and the localization system 230 may provide positions of one or more points on the cargo platform. For example, a cargo platform may include a trailer or other device towed or otherwise attached to or manipulated by an autonomous platform 110, and the localization system 230 may provide for data describing the position (e.g., absolute, relative) of the autonomous platform 110 as well as the cargo platform. Such information may be obtained by the other autonomy systems to help operate the autonomous platform 110.

The autonomy system 200 may include the perception system 240, which may allow an autonomous platform 110 to detect, classify, and track objects in the environment of the autonomous platform 110. Environmental features or objects perceived within an environment may be those within the field of view of the sensor(s) 202 or predicted to be occluded from the sensor(s) 202. This may include object(s) not in motion or not predicted to move (static objects) or object(s) in motion or predicted to be in motion (dynamic objects/actors). In an embodiment, this may include extensions of static object(s) or dynamic objects/actors.

The perception system 240 may determine one or more states (e.g., current or past state(s)) of one or more objects that are within a surrounding environment of an autonomous platform. For example, state(s) may describe (e.g., for a given time, time period) an estimate of an object's current or past location (also referred to as position); current or past speed/velocity; current or past acceleration; current or past heading; current or past orientation; size/footprint (e.g., as represented by a bounding shape, object highlighting); classification (e.g., pedestrian class vs. vehicle class vs. bicycle class); the uncertainties associated therewith; other state information; or any combination thereof. With reference to traffic control nodes, in some implementations, state information may further describe an estimated point in a progression through a series of states, where the traffic control node progresses through the series of states to signal authorization for vehicles to enter and/or exit a location (e.g., an intersection, a stop point) by different directions and/or lanes. Furthermore, each state in the series of states may selectively operate one or more traffic signaling devices to signal the authorized entry and/or exit for the state. For example, each state in the series of states may selectively illuminate a bulb element of each traffic signaling device, where the bulb elements are configured according to a convention for signaling authorization.

In some implementations, the perception system 240 may determine the state(s) using one or more algorithms or machine-learned models configured to identify/classify objects based on inputs from the sensor(s) 202. The perception system 240 may use different modalities of the sensor data 204 to generate a representation of the environment to be processed by the one or more algorithms or machine-learned models. In some implementations, state(s) for one or more identified or unidentified objects may be maintained and updated over time as the autonomous platform continues to perceive or interact with the objects (e.g., maneuver with or around, yield to). In this manner, the perception system 240 may provide an understanding about a current state of an environment (e.g., including the objects therein) informed by a record of prior states of the environment (e.g., including movement histories for the objects therein). Such information may be helpful as the autonomous platform plans its motion through the environment.

In some implementations, the functionality described herein respective to determining traffic signal state detection may be incorporated into or otherwise associated with the perception system 240. For instance, the control node graph processing model can be a part of and/or can be operated by the perception system 240. Still further, in some implementations, the functionality described herein respective to determining traffic signal state detection may be

The autonomy system 200 may include the planning system 250, which may be configured to determine how the autonomous platform 110 is to interact with and move within its environment. The planning system 250 may determine one or more motion plans for an autonomous platform. A motion plan may include one or more trajectories (e.g., motion trajectories) that indicate a path for an autonomous platform to follow. A trajectory may be of a certain length or time range. The length or time range may be defined by the planning system 250. A motion trajectory may be defined by one or more waypoints (with associated coordinates). The waypoint(s) may be future location(s) for the autonomous platform. The motion plans may be continuously generated, updated, and considered by the planning system 250.

The planning system 250 may determine a strategy for the autonomous platform. A strategy may be a set of discrete decisions (e.g., yield to actor, reverse yield to actor, merge, lane change) that the autonomous platform makes. The strategy may be selected from a plurality of potential strategies. The selected strategy may be a lowest cost strategy as determined by one or more cost functions. The cost functions may, for example, evaluate the probability of a interfering with another object.

The planning system 250 may determine a desired trajectory for executing a strategy. For instance, the planning system 250 may obtain one or more trajectories for executing one or more strategies. The planning system 250 may evaluate trajectories or strategies (e.g., with scores, costs, rewards, constraints) and rank them. For instance, the planning system 250 may use forecasting output(s) that indicate interactions (e.g., proximity, intersections) between trajectories for the autonomous platform and one or more objects to inform the evaluation of candidate trajectories or strategies for the autonomous platform. In some implementations, the planning system 250 may utilize static cost(s) to evaluate trajectories for the autonomous platform (e.g., “avoid lane boundaries,” “minimize jerk,”). Additionally or alternatively, the planning system 250 may utilize dynamic cost(s) to evaluate the trajectories or strategies for the autonomous platform based on forecasted outcomes for the current operational scenario (e.g., forecasted trajectories or strategies leading to interactions between actors, forecasted trajectories or strategies leading to interactions between actors and the autonomous platform). The planning system 250 may rank trajectories based on one or more static costs, one or more dynamic costs, or a combination thereof. The planning system 250 may select a motion plan (and a corresponding trajectory) based on a ranking of a plurality of candidate trajectories. In some implementations, the planning system 250 may select a highest ranked candidate, or a highest ranked feasible candidate.

The planning system 250 may then validate the selected trajectory against one or more constraints before the trajectory is executed by the autonomous platform 110.

To help with its motion planning decisions, the planning system 250 may be configured to perform a forecasting function. The planning system 250 may forecast future state(s) of the environment. This may include forecasting the future state(s) of other actors in the environment. In some implementations, the planning system 250 may forecast future state(s) based on current or past state(s) (e.g., as developed or maintained by the perception system 240). In some implementations, future state(s) may be or include one or more forecasted trajectories (e.g., positions over time) of the objects in the environment, such as other actors. In some implementations, one or more of the future state(s) may include one or more probabilities associated therewith (e.g., marginal probabilities, conditional probabilities). For example, the one or more probabilities may include one or more probabilities conditioned on the strategy or trajectory options available to the autonomous platform 110. Additionally or alternatively, the probabilities may include probabilities conditioned on trajectory options available to one or more other actors.

In some implementations, the planning system 250 may perform interactive forecasting. The planning system 250 may determine a motion plan for an autonomous platform 110 with an understanding of how forecasted future states of the environment 100 may be affected by execution of one or more candidate motion plans.

By way of example, with reference again to FIG. 1, the autonomous platform 110 may determine candidate motion plans corresponding to a set of platform trajectories 112A-C that respectively correspond to the first actor trajectories 122A-C for the first actor 120, second actor trajectories 132 for the second actor 130, and third actor trajectories 142 for the third actor 140 (e.g., with respective trajectory correspondence indicated with matching line styles). For instance, the autonomous platform 110 (e.g., using its autonomy system 200) may forecast that a platform trajectory 112A to more quickly move the autonomous platform 110 into the area in front of the first actor 120 is likely associated with the first actor 120 decreasing forward speed and yielding more quickly to the autonomous platform 110 in accordance with first actor trajectory 122A. Additionally or alternatively, the autonomous platform 110 may forecast that a platform trajectory 112B to gently move the autonomous platform 110 into the area in front of the first actor 120 is likely associated with the first actor 120 slightly decreasing speed and yielding slowly to the autonomous platform 110 in accordance with first actor trajectory 122B. Additionally or alternatively, the autonomous platform 110 may forecast that a platform trajectory 112C to remain in a parallel alignment with the first actor 120 is likely associated with the first actor 120 not yielding any distance to the autonomous platform 110 in accordance with first actor trajectory 122C. Based on comparison of the forecasted scenarios to a set of desired outcomes (e.g., by scoring scenarios based on a cost or reward), the planning system 250 may select a motion plan (and its associated trajectory) in view of the autonomous platform's interaction with the environment 100. In this manner, for example, the autonomous platform 110 may achieve at least a technical improvement that interleaves its forecasting and motion planning functionality.

To implement selected motion plan(s), the autonomy system 200 may include a control system 260 (e.g., a vehicle control system). Generally, the control system 260 may provide an interface between the autonomy system 200 and the platform control devices 212 for implementing the strategies and motion plan(s) generated by the planning system 250. For instance, the control system 260 may implement the selected motion plan/trajectory to control motion of the autonomous platform 110 through its environment 100 by following the selected trajectory (e.g., the waypoints included therein). The control system 260 may, for example, translate a motion plan into instructions for the appropriate platform control devices 212 (e.g., acceleration control, brake control, steering control). By way of example, the control system 260 may translate a selected motion plan into instructions to adjust a steering component (e.g., a steering angle) by a certain number of degrees, apply a certain magnitude of braking force, increase/decrease speed, or implement other motion controls. In some implementations, the control system 260 may communicate with the platform control devices 212 through communication channels including, for example, one or more data buses (e.g., controller area network (CAN)), onboard diagnostics connectors (e.g., OBD-II), or a combination of wired or wireless communication links. The platform control devices 212 may send or obtain data, messages, signals (or other types of communication) to or from the autonomy system 200 (or vice versa) through the communication channel(s).

The autonomy system 200 may receive, through communication interface(s) 206, assistive signal(s) from remote assistance system 270. Remote assistance system 270 may communicate with the autonomy system 200 over a network (e.g., as a remote system 160 over network 170). In some implementations, the autonomy system 200 may initiate a communication session with the remote assistance system 270. For example, the autonomy system 200 may initiate a session based on or based on a trigger. In some implementations, the trigger may be an alert, an error signal, a map feature, a request, a location, a traffic condition, a road condition, or other trigger.

After initiating the session, the autonomy system 200 may provide context data to the remote assistance system 270. The context data may include sensor data 204 and state data of the autonomous platform. For example, the context data may include a live camera feed from a camera of the autonomous platform and a current speed of the autonomous platform 110. An operator (e.g., human operator) of the remote assistance system 270 may use the context data to select one or more assistive signals. The assistive signal(s) may provide values or adjustments for various operational parameters or characteristics for the autonomy system 200. For instance, the assistive signal(s) may include way points (e.g., a path around an obstacle, lane change), velocity or acceleration profiles (e.g., speed limits), relative motion instructions (e.g., convoy formation), operational characteristics (e.g., use of auxiliary systems, reduced energy processing modes), or other signals to assist the autonomy system 200.

The autonomy system 200 may use the assistive signal(s) for input into one or more autonomy subsystems for performing autonomy functions. For instance, the planning system 250 may receive the assistive signal(s) as an input for generating a motion plan. For example, assistive signal(s) may include constraints for generating a motion plan. Additionally or alternatively, assistive signal(s) may include cost or reward adjustments for influencing motion planning by the planning system 250. Additionally or alternatively, assistive signal(s) may be considered by the autonomy system 200 as suggestive inputs for consideration in addition to other received data (e.g., sensor inputs).

The autonomy system 200 may be platform agnostic, and the control system 260 may provide control instructions to platform control devices 212 for a variety of different platforms for autonomous movement (e.g., a plurality of different autonomous platforms fitted with autonomous control systems). This may include a variety of different types of autonomous vehicles (e.g., sedans, vans, SUVs, trucks, electric vehicles, combustion power vehicles) from a variety of different manufacturers/developers that operate in various different environments and, in some implementations, perform one or more vehicle services.

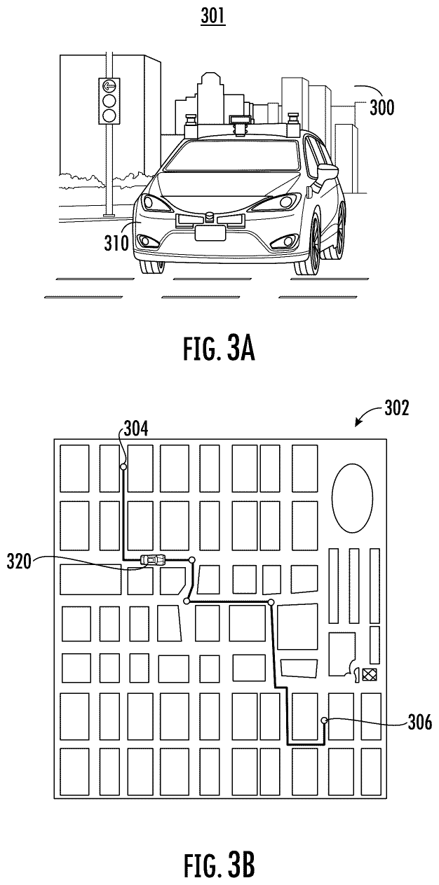

For example, with reference to FIG. 3A, an operational environment 301 may include a dense environment 300. An autonomous platform may include an autonomous vehicle 310 controlled by the autonomy system 200. In some implementations, the autonomous vehicle 310 may be configured for maneuverability in a dense environment, such as with a configured wheelbase or other specifications. In some implementations, the autonomous vehicle 310 may be configured for transporting cargo or passengers. In some implementations, the autonomous vehicle 310 may be configured to transport numerous passengers (e.g., a passenger van, a shuttle, a bus). In some implementations, the autonomous vehicle 310 may be configured to transport cargo, such as large quantities of cargo (e.g., a truck, a box van, a step van) or smaller cargo (e.g., food, personal packages).

With reference to FIG. 3B, a selected overhead view 302 of the dense environment 300 is shown overlaid with an example trip/service between a first location 304 and a second location 306. The example trip/service may be assigned, for example, to an autonomous vehicle 320 by a remote computing system. The autonomous vehicle 320 may be, for example, the same type of vehicle as autonomous vehicle 310. The example trip/service may include transporting passengers or cargo between the first location 304 and the second location 306. In some implementations, the example trip/service may include travel to or through one or more intermediate locations, such as to onload or offload passengers or cargo. In some implementations, the example trip/service may be prescheduled (e.g., for regular traversal, such as on a transportation schedule). In some implementations, the example trip/service may be on-demand (e.g., as requested by or for performing a taxi, rideshare, ride hailing, courier, delivery service).

With reference to FIG. 3C, in another example, an operational environment 311 may include an open travel way environment 330. An autonomous platform may include an autonomous vehicle 350 controlled by the autonomy system 200. This may include an autonomous tractor for an autonomous truck. In some implementations, the autonomous vehicle 350 may be configured for high payload transport (e.g., transporting freight or other cargo or passengers in quantity), such as for long distance, high payload transport. For instance, the autonomous vehicle 350 may include one or more cargo platform attachments such as a trailer 352. Although depicted as a towed attachment in FIG. 3C, in some implementations one or more cargo platforms may be integrated into (e.g., attached to the chassis of) the autonomous vehicle 350 (e.g., as in a box van, step van).

With reference to FIG. 3D, a selected overhead view 331 of open travel way environment 330 is shown, including travel ways 332, an interchange 334, transfer hubs 336 and 338, access travel ways 340, and locations 342 and 344. In some implementations, an autonomous vehicle (e.g., the autonomous vehicle 310 or the autonomous vehicle 350) may be assigned an example trip/service to traverse the one or more travel ways 332 (optionally connected by the interchange 334) to transport cargo between the transfer hub 336 and the transfer hub 338. For instance, in some implementations, the example trip/service includes a cargo delivery/transport service, such as a freight delivery/transport service. The example trip/service may be assigned by a remote computing system. In some implementations, the transfer hub 336 may be an origin point for cargo (e.g., a depot, a warehouse, a facility) and the transfer hub 338 may be a destination point for cargo (e.g., a retailer). However, in some implementations, the transfer hub 336 may be an intermediate point along a cargo item's ultimate journey between its respective origin and its respective destination. For instance, a cargo item's origin may be situated along the access travel ways 340 at the location 342. The cargo item may accordingly be transported to the transfer hub 336 (e.g., by a human-driven vehicle, by the autonomous vehicle 310) for staging. At the transfer hub 336, various cargo items may be grouped or staged for longer distance transport over the travel ways 332.

In some implementations of an example trip/service, a group of staged cargo items may be loaded onto an autonomous vehicle (e.g., the autonomous vehicle 350) for transport to one or more other transfer hubs, such as the transfer hub 338. For instance, although not depicted, it is to be understood that the open travel way environment 330 may include more transfer hubs than the transfer hubs 336 and 338, and may include more travel ways 332 interconnected by more interchanges 334. A simplified map is presented here for purposes of clarity only. In some implementations, one or more cargo items transported to the transfer hub 338 may be distributed to one or more local destinations (e.g., by a human-driven vehicle, by the autonomous vehicle 310), such as along the access travel ways 340 to the location 344. In some implementations, the example trip/service may be prescheduled (e.g., for regular traversal, such as on a transportation schedule). In some implementations, the example trip/service may be on-demand (e.g., as requested by or for performing a chartered passenger transport or freight delivery service).

To help improve the performance of an autonomous platform, such as an autonomous vehicle controlled at least in part using autonomy system(s) 200 (e.g., the autonomous vehicles 310 or 350), the perception system 240 may detect state information of traffic signals (e.g., traffic control nodes) as described further herein.

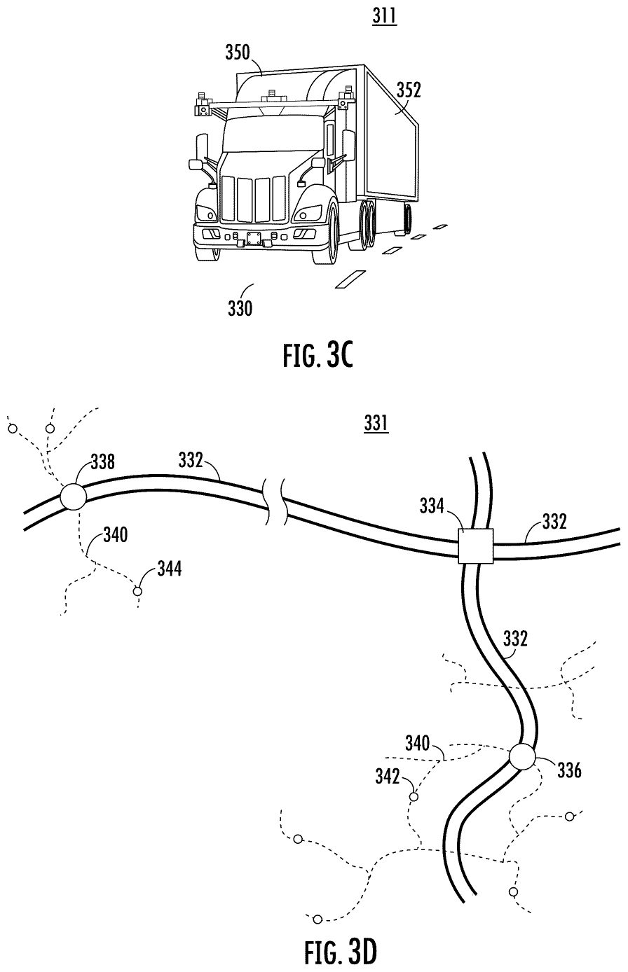

FIG. 4 is a block diagram 400 including a traffic signal state detection system 401 (also referred to as “detection system 401”), according to some implementations of the present disclosure. The detection system 401 may be included, for example within the perception system 240 of an autonomous vehicle and/or may be included in parallel with the perception system 240 of an autonomous vehicle. Although FIG. 4 illustrates an example implementation of a detection system 401 having various components, it is to be understood that the components may be rearranged, combined, supplemented, or omitted, within the scope of and consistent with the present disclosure.

To help detect objects and their extensions, the detection system 401 may obtain environment data 402. As described herein, the environment data 402 may include sensor data 204 captured through one or more sensors 202 onboard an autonomous vehicle. This may include RADAR data, LIDAR data, image data, or other types of data. For example, the environment data 402 may include image frames captured during instances of real-world driving, and associated times in which the objects in the environment were perceived. The environment data 402 may include data collected from other sources (e.g. roadside cameras, aerial vehicles, other vehicles).

The environment data 402 may be associated with a plurality of times. By way of example, the environment data 402 may include a plurality of image frames indicative of or descriptive of a traffic signal device in an environment of the autonomous vehicle. Each respective image frame may be associated with a time/time stamp at which the image frame was captured. For instance, the plurality of image frames may include a sequence of image frames taken across a plurality of times and depicting an object in the environment. Furthermore, in some implementations, each respective image frame may be associated with a sensor (e.g., a camera) from which the image frame was obtained. For example, in some implementations, an autonomous vehicle may be provided with a plurality of cameras having varying aspects (e.g., field of view, resolution) and the environment data 402 can include image frames from each of the plurality of cameras.

As described herein, the environment data 402 may describe a traffic signal device within an environment of the autonomous vehicle. As used herein, a “traffic signal device” can refer to a device configured to indicate the authorized movement of vehicles, pedestrians, and/or other actors within an intersection or along a direction of travel. A traffic signal device may be, for example, a device otherwise referred to as a “traffic light,” “stoplight,” “pedestrian hybrid beacon” or “PHB”, “high-intensity activated crosswalk beacon” or “HAWK beacon”, or other suitable indicator device. The traffic signal device may generally follow an understood convention for signaling the authorized flow of traffic. For example, the traffic signal device may include one or more bulb elements that are selectively lit to indicate whether actors are authorized to proceed or not. The colors, shapes, patterns, and/or arrangement of the bulb elements can convey information relating to the authorized movement of actors (e.g., vehicles, pedestrians) within an area controlled by the traffic signal device. The area controlled by the traffic signal device can be or can include, for example, a vehicle lane, a bicycle lane, a pedestrian walkway or sidewalk, a crosswalk, an intersection, a drawbridge, or other feature providing for the selective allowance or disallowance of passage through the area. The environment may be, for example, the environment outside of and surrounding the autonomous vehicle (e.g., within a sensor field of view). In some implementations, the environment data 402 may include video data. Additionally, or alternatively, the environment data 402 may include multiple single, static images.

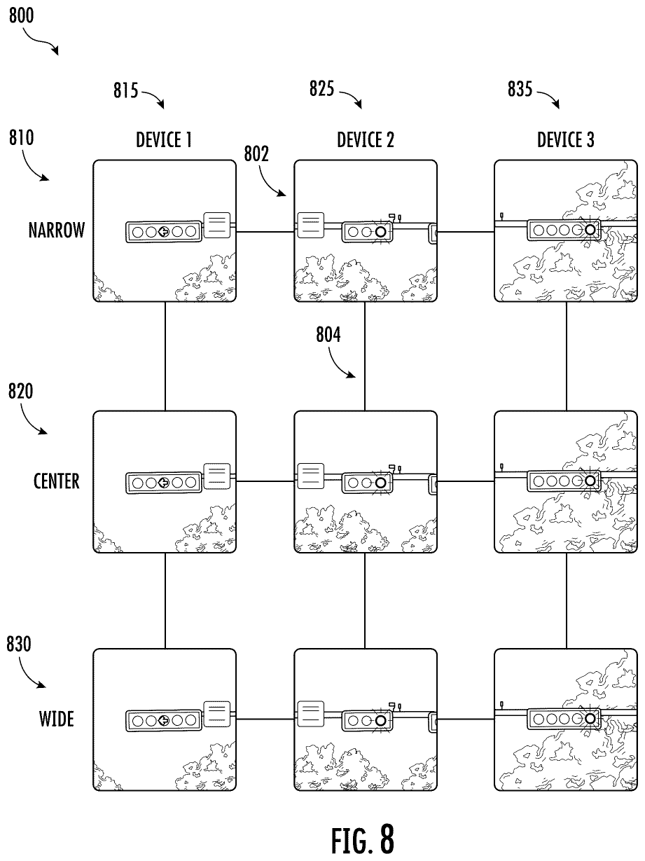

The detection system 401 can generate a control node graph 404 based on the environment data 402. The control node graph 404 can include vertices respective to representations of traffic signal devices in the data and edges indicative of relationships between the representations of the traffic signal devices corresponding to a control node in the environment data 402. For instance, the control node graph 404 can include vertices corresponding to one or more representations of each traffic signal device of the traffic control node in the environment data 402 and/or edges between the vertices defining relationships between the representations. For example, in some implementations, an edge between a first vertex and a second vertex can indicate that the first vertex and the second vertex share a same scene or a same time instance, depict a common traffic signal device, depict adjacent traffic signal devices, or otherwise share some relationship. Some example control node graphs are illustrated herein in FIGS. 8-13.

The traffic signal state detection system 401 can provide the control node graph 404 as input to a control node graph processing model 410. Control node graph processing model 410 can be operable to reduce the control node graph 404 to a distilled representation of the control node graph 404. The distilled representation of the control node graph 404 can be a relatively smaller amount of data than the control node graph 404. Furthermore, the distilled representation can encode information about a state of the traffic control node. For example, the control node graph processing model 410 can be operable to extract relevant state information from the control node graph 404 and generate an output that encodes that state information in a data-efficient manner. As one example, the distilled representation of the control node graph 404 can be an embedding of the control node graph 404. In some implementations, the control node graph embedding can have a plurality of values that convey information about the state information. Additionally or alternatively, the distilled representation of the control node graph 404 may be a one-hot embedding of the control node graph 404, where the hot value represents the present state of the traffic control node.

The control node graph processing model 410 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. In some implementations, the control node graph processing model 410 can be or can include a graph neural network (GNN) or graph attention network (GAT).

The control node graph processing model 410 may be trained through the use of one or more model trainers and training data. The model trainers may be trained using one or more training or learning algorithms. One example training technique is backwards propagation of errors. In some examples, simulations may be implemented for obtaining the training data or for implementing a model trainer for training or testing the model. In some examples, a model trainer may perform supervised training techniques using labeled training data. In some examples, the training data may include simulated training data (e.g., training data obtained from simulated scenarios, inputs, configurations, environments).

Additionally, or alternatively, a model trainer may perform unsupervised training techniques using unlabeled training data. By way of example, a model trainer may train one or more components of a machine-learned model to perform object detection through unsupervised training techniques using an objective function (e.g., costs, rewards, heuristics, constraints). In some implementations, a model trainer may perform a number of generalization techniques to improve the generalization capability of the model(s) being trained. Generalization techniques include weight decays, dropouts, or other techniques.

The control node graph processing model 410 can, based on receipt of the control node graph 404 as input, generate output data 406. In some implementations, the output data 406 of the control node graph processing model 410 can be the distilled representation of the control node graph 404. Additionally or alternatively, in some implementations, the output data 406 of the control node graph processing model can be based on the distilled representation of the control node graph 404. For example, the output data 406 can be state data derived from the distilled representation.

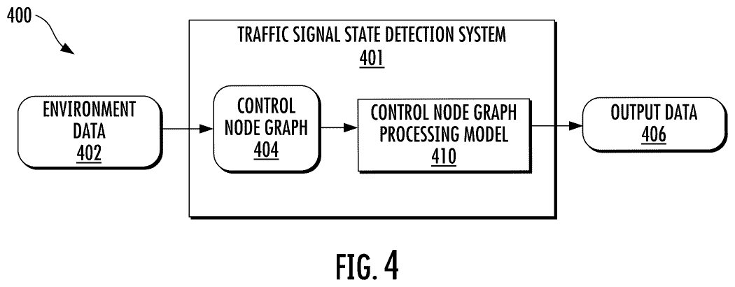

FIG. 5 is a block diagram 500 including a traffic signal state detection system 501 (also referred to as “detection system 501”), according to some implementations of the present disclosure. The detection system 501 may be included in parallel with the perception system 240 of an autonomous vehicle, as illustrated. In some implementations, the traffic signal state detection system 501 may be included within the perception system 240. Although FIG. 5 illustrates an example implementation of a detection system 501 having various components, it is to be understood that the components may be rearranged, combined, supplemented, or omitted, within the scope of and consistent with the present disclosure.

The perception system 240 can obtain environment data 504. In the example of FIG. 5, the environment data 504 is obtained from multiple data channels including a first data channel 502 and a second data channel 503. For example, each of the first data channel 502 and the second data channel 503 may be associated with a unique data stream, sensor, or other input source.

The perception system 240 can generate traffic signal representations 505 that include representations of the traffic signals in the environment data 504. The traffic signal representations 505 in the environment data 504 can be any suitable representation. As one example, in some implementations, the traffic signal representations 505 can be crops or portions of environment data 504 from a larger set of initial environment data 504. For example, in some implementations, the perception system 240 can receive initial environment data 504. For instance, the initial environment data can be or can include a scan or sweep of a field of view of a sensor device, a stored scan or image, or other relatively larger data that depicts the traffic signal devices and may depict other elements that are not the traffic signal devices. The perception system 240 can generate RoI data associated with each traffic signal device in the initial environment data 504. The RoI data can include, for example, coordinates, bounding boxes, or other information that is descriptive of a portion of the initial environment data 504 respectively associated with a traffic signal device. The perception system 240 (or another system) can extract the traffic signal representations 505 including the portions of the initial environment data 504 respectively associated with the one or more traffic signal devices based on the data descriptive of the portions of the initial environment data 504 associated with the traffic signal devices. For example, if the initial environment data 504 is a scan, sweep, or image, extracting the environment data 504 can include cropping the scan, sweep, or image to include only data bounded by or within the region of interest.

As another example, in some implementations, the traffic signal representations 505 in the environment can be or can include a transformed or distilled representation of the environment data 504 corresponding to the traffic signal devices. For example, in some implementations, the environment data 504 corresponding to a particular traffic signal device may be extracted for a region of interest as described above. The extracted environment data can be used to generate a distilled representation of the environment data 504 corresponding to the particular traffic signal device. As one example, the distilled representation can be an embedding.

Based on the traffic signal representations 505, the traffic signal state detection system 501 can generate a control node graph 506. The control node graph 506 can include vertices corresponding to each traffic signal representation 505 and/or edges indicating spatiotemporal relationships between the traffic signal devices and/or traffic signal representations 505. For instance, representations 505 from these data channels 502, 503 (e.g., corresponding to multiple sensor devices or data sources) can be used to produce multiple vertices and/or an aggregate vertex for a traffic signal device. For example, in some implementations, an autonomous vehicle can include a plurality of sensor devices (e.g., cameras), where each sensor device can produce representations of a common traffic signal device in channels of environment data (e.g., sensor device data) from each sensor device. The representations 505 can each correspond to a vertex in the control node graph 506, and may be grouped by edges indicating that the representations 505 depict a common traffic signal device. As another example, in some implementations, the representations 505 from each data channel (e.g., 502, 503) can be combined into a single aggregate vertex that includes or corresponds to the representations from each data channel (e.g., 502, 503). Fusing representations 505 from the plurality of channels (e.g., 502, 503) can provide for improved consistency of outputs as the autonomous vehicle navigates throughout the environment. For example, the output can be robust to changes in availability or priority of information from each channel.

Based on a control node graph processing model 510, the traffic signal state detection system 501 can generate an output including control node state data 508. The control node state data 508 can be descriptive of an internal state of the traffic control node depicted within the environment data 504. For instance, the control node state data 508 can be a classification, encoding, or other suitable representation of state data. The traffic signal state detection system 501 can provide the control node state data 508 to a planning system 250 (e.g., in addition to and/or included within perception data 245 from the perception system 240). The planning system 250 can generate a motion plan 255, which may be provided to downstream components (e.g., a control system 260) for controlling an autonomous vehicle.

The control node graph processing model 510 can generate a distilled representation 518 of the control node graph 506 and generate the control node state data 508 based on the distilled representation 518. For instance, the control node graph processing model 510 can include a first mechanism 515 that is operable to generate the distilled representation 518 of the control node graph 506 based on receipt of the control node graph 506 as input. Additionally or alternatively, the control node graph processing model 510 can include a second mechanism 520 that is operable to convert the distilled representation 518 of the control node graph 506 to state data indicative of a state of the traffic control node. For example, some downstream systems of an autonomous vehicle computing system can utilize the state data 508 as output of the control node graph processing model 510, but may not necessarily be capable of meaningfully processing the distilled representation 518 of the control node graph 506.

The first mechanism 515 and/or the second mechanism 520 can be any suitable mechanism or portion of the control node graph processing model 510. As examples, the first mechanism 515 and/or the second mechanism 520 can include one or more layers of the control node graph processing model 510, a submodel of the control node graph processing model 510, a pipeline or data stream within the control node graph processing model 510, or any other suitable mechanism. As one example, in some implementations, the first mechanism 515 can be a neural network, such as a convolutional neural network. As another example, in some implementations, the second mechanism 520 can be a temporal neural network. For instance, the second mechanism 520 can operate over temporally related traffic signal representations 505 to capture the temporal relationships in the traffic signal representations 505. In some implementations, the first mechanism 515 includes a plurality of first layers configured to reduce the control node graph 506 to the distilled representation 518 of the control node graph 506 and the second mechanism 520 includes a plurality of second layers configured to build the state data 508 based on the distilled representation 518 of the control node graph 506. As another example, in some implementations, the second mechanism 520 can be or can include an attention mechanism configured to operate on neighboring vertices to extract relevant data during processing of the first mechanism 515.

In some implementations, the control node graph 506 can be processed by the first mechanism 515 (e.g., a convolutional neural network) to extract device-level features from the traffic signal representations 505. Furthermore, in some implementations, a device-level feature processing layer can perform additional processing or distillation operations can be performed on the device-level features to derive node-level features from the device-level features. The additional processing or distillation operations can be performed (e.g., by the device-level feature processing layer) at one of the first mechanism 515 or the second mechanism 520.

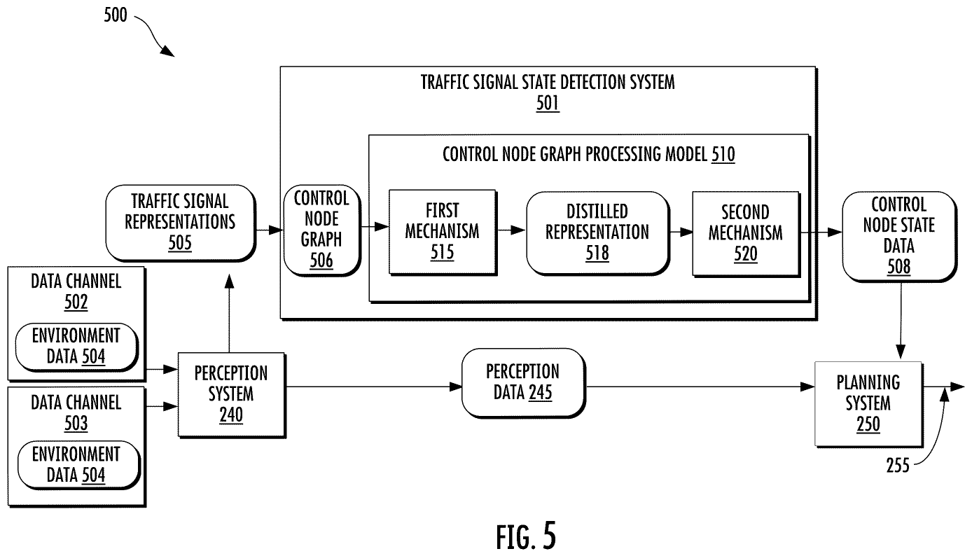

FIG. 6 depicts an example traffic signal device 600 according to some implementations of the present disclosure. The traffic signal device 600 includes a plurality of bulb elements 602 or sections. Five bulb elements 602 are illustrated in the traffic signal device 600, but more or fewer bulb elements 602 can be included on a traffic signal device without deviating from the scope of the present disclosure. The bulb elements 602 can be selectively lit to indicate whether actors are authorized to proceed or not through an area controlled by the traffic signal device 600. The colors, shapes, patterns, and/or arrangement of the bulb elements 602 can convey information relating to the authorized movement of actors.

The traffic signal device 600 includes bulb elements 602 associated with a first control set 605 and a second control set 610, More particularly, the top bulb element 602 and the two lower right bulb elements 602 are associated with the first control set 605 (e.g., a “main” control set) and the two lower left bulb elements 602 are associated with the second control set 610 (e.g., a “left” control set). The top bulb element 602 may also be associated with the second control set 610 (e.g., concurrently). As used herein, a “control set” refers to a set of one or more bulb elements 602 that control a particular direction or mode of travel through the area controlled by a traffic signal device. For example, the first control set 605 (e.g., the “main” control set) can control traffic proceeding straight through the area. Additionally or alternatively, the second control set 610 (e.g., the “left” control set) can control traffic turning left through the area. The traffic signal device 600 can be included in a traffic control node that additionally includes other traffic signal devices controlling most or all directions of travel (e.g., for a single incoming direction) across the area covered by the traffic control node.

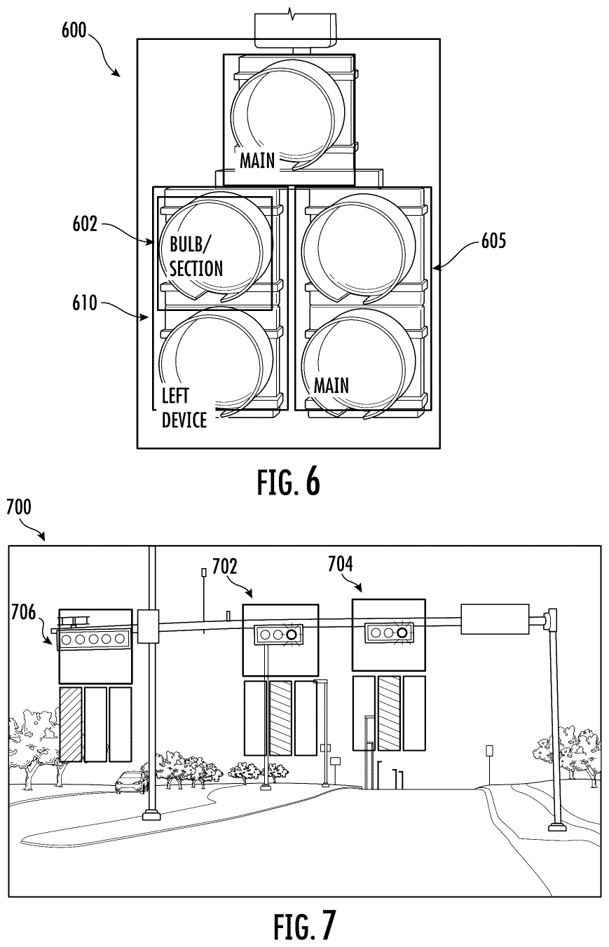

FIG. 7 depicts an example traffic control node 700 according to some implementations of the present disclosure. The traffic control node 700 can include a first traffic signal device 702, a second traffic signal device 704, and a third traffic signal device 706. It should be understood that more or fewer traffic signal devices can be included in a traffic control node without deviating from the scope of the present disclosure. The traffic control node 700 illustrated in FIG. 7 controls two outgoing directions of travel from a single incoming direction of travel across an intersection. For instance, the first traffic signal device 702 can control a first lane and the second traffic signal device 704 can control a second lane, where the first lane and the second lane both proceed in a first direction of travel. The control of the first traffic signal device 702 and the second traffic signal device 704 may, therefore, be similar or identical for all states of the traffic control node 700. The third traffic signal device 706 can control a second direction of travel, such as a left turn across the intersection. The third traffic signal device 706 may therefore be controlled separately from the first traffic signal device 702 and the second traffic signal device 704. The internal state of the traffic control node 700 can therefore describe which bulb element(s) are illuminated on each of the first traffic signal device 702, the second traffic signal device 704, and the third traffic signal device 706. Additionally or alternatively, in some implementations, the state of the traffic control node 700 may be respective to the first direction of travel and the second direction of travel rather than respective to the individual traffic signal devices 702, 704, and 706. For example, the traffic control node 700 and the determined state data for the traffic control node 700 may lack dedicated states for differing or individual control of the first traffic signal device 702 and the second traffic signal device 704.

Traffic control nodes can present in various sizes and configurations (e.g., having devices signaling for one or more control sets). To utilize some convolutional neural networks (CNNs), tensors within a batch must each have the same size, which can in turn require handling the largest input size for every control node at each frame. This can be challenging for resource-constrained autonomous driving applications. For instance, inputs would need to be sized for the largest possible traffic control node that the model is required to handle, and computing resources for processing those inputs could be identical even for significantly simpler traffic control nodes. The use of a graph neural network trained to produce a distilled representation, however, can provide improved (e.g., more efficient) processing of graphs having differing size and/or connectivity. By utilizing a control node graph in combination with a control node graph processing model, such as a graph neural network or similarly efficient graph-based model, the present disclosure can provide an end-to-end model that considers both spatial and temporal aspects of traffic control nodes when outputting states of the traffic control nodes.

FIG. 8 depicts an example control node graph 800 according to some implementations of the present disclosure. The control node graph 800 includes a plurality of vertices 802 connected by a plurality of edges 804. Each vertex 802 can correspond to a traffic signal representation from a channel of sensor data. Furthermore, the edges 804 can be indicative of spatial, temporal, and/or conceptual relationships between the vertices 802. For instance, in some implementations, each sensor device on an autonomous vehicle can produce representations of a common traffic signal device in channels of environment data (e.g., sensor device data) from each sensor device. The representations can each correspond to a vertex 802 in the control node graph 800, and may be grouped by edges 804 indicating that the representations depict a common traffic signal device. For example, in the control node graph 800 depicted in FIG. 8, the edges 804 generally set out a first row 810, a second row 820, and a third row 830 of the graph 800 and a first column 815, a second column 825, and a third column 835 of the graph 800. The first row 810, second row 820, and third row 830 can each correspond to representations from different sensors. For example, the first row 810 includes representations from a narrow-view camera, the second row 820 includes representations from a center-view camera, and the third row 830 includes representations from a wide-view camera. Furthermore, the first column 815, the second column 825, and the third column 835 can each correspond to representations of different traffic signal devices of a traffic control node. For example, the first column 815 includes representations of a first traffic signal device (e.g., a left turn indicator), the second column 825 includes representations of a second traffic signal device (e.g., a straight travel indicator), and the third column 835 includes representations of a third traffic signal device (e.g., a straight and right turn indicator). In this manner, the graph 800 includes (e.g., undirected) edges 804 that represent a left to right connectivity between adjacent devices, and a higher resolution to lower resolution connectivity between the sensor data representations from different cameras.

It should be understood that while the control node graph 800 is depicted using explicit graph conventions such as nodes and edges coupling nodes in FIG. 8, other such conventions may be utilized in representing the control node graphs in accordance with example aspects of the present disclosure. For example, in some implementations, control node graphs can be represented implicitly by positioning of representations within an image. For example, representations may be assembled into an image (e.g., a single image) where relative pixel positions within the image are reflective of relationships between the representations. For example, representations having pixels with shared X-coordinate or Y-coordinate values may share relationships that are reflected by the X-coordinate or Y-coordinate values. As another example, representations may be assembled into a multi-channel image where different channels represent different forms of the representations.

Furthermore, more or fewer edges can be included in a control node graph according to example aspects of the present disclosure. For example, in some implementations, the control node graph may be strongly connected such that each node is connected to each other node in the control node graph. Aspects of the connections between nodes may be represented by attributes such as weights of the edges or proximity. As one example, an attention mechanism (e.g., in the second mechanism) can learn weights of the edges in a control node graph that are semantically meaningful for representing interrelationships within a control node.

One example approach for maintaining consistency as devices appear and disappear from the field of view of the autonomous vehicle sensors is to find all devices at the outset, find an initial ordering (i.e. based on bearing from vehicle pose), and then use that order placement for each device regardless of how many devices are visible.

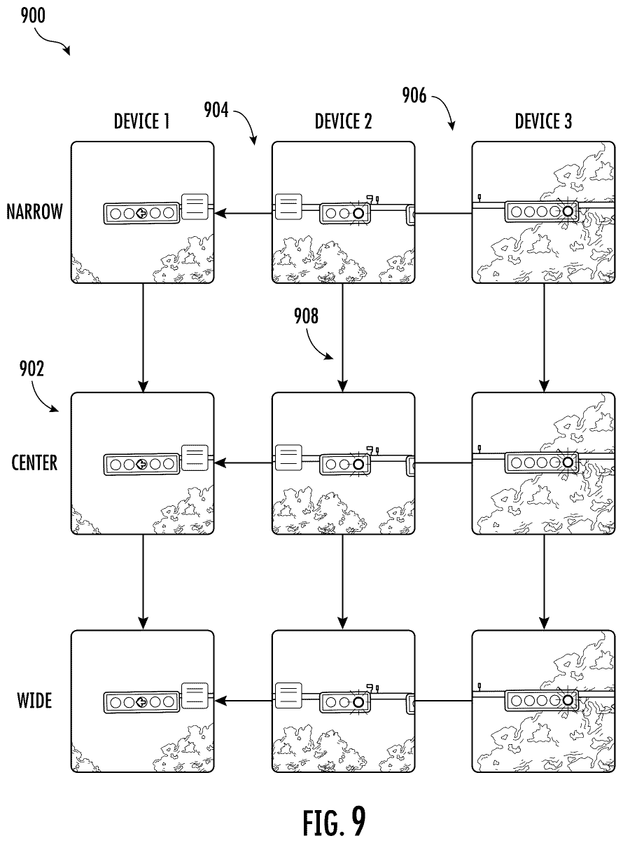

FIG. 9 depicts another example control node graph 900 according to some implementations of the present disclosure. For instance, while the relatively simple graph 800 of FIG. 8 may be sufficient for many applications, the graph 900 of FIG. 9 includes additional refinements to produce a more nuanced, directed representation of the traffic control node. For example, the graph 900 includes directed edges 904 between vertices 902 corresponding to different control sets. For example, directed edges 904 span between vertices of a main control set and left/right control sets. Furthermore, undirected edges 906 span between vertices corresponding to devices in the same control set (e.g., between two devices in the main control set). Finally, directed edges 908 can span from higher resolution representations to lower resolution representations to “flow” features from the higher resolutions to the lower resolutions. This can provide for reduced dilution in features derived from higher detail data; for example, edges of a left turn bulb element. Additionally and/or alternatively, in some implementations, edges between some devices in the same control set, such as devices that are not spatially adjacent, may be omitted from a control node graph. Furthermore, in some implementations, several different edge types can be utilized additionally to and/or alternatively to directed or undirected edges. Edge type processing functionality can be included into the control node graph processing model to determine spatiotemporal relationships based on the edge types.

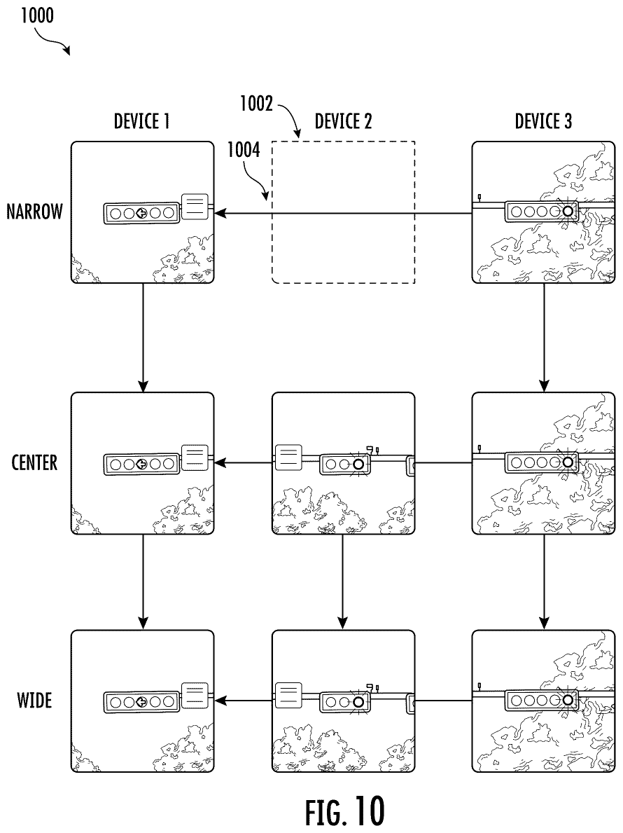

The example graphs 800 and 900 of FIGS. 8-9 depict “full” graphs for a given intersection, where each device is in view of each sensor element. However, in some instances, it can be advantageous to determine how to form edges between vertices of a graph having “missing” representations. FIG. 10 depicts another example control node graph 1000 according to some implementations of the present disclosure. For instance, in the graph 1000, the representation 1002 of the second traffic signal device from the first sensor (e.g., the narrow-view camera) is missing. For example, the second traffic signal device may be out of view of the first sensor due to the relative position of the autonomous vehicle; for example, if the autonomous vehicle is in a different lane from the second traffic signal device, or if the second traffic signal device is occluded by an actor or another occlusion. The traffic signal state detection system can determine whether or not to form an edge 1004 in place of the representation 1002, thereby connecting representations from otherwise non-adjacent control sets. For example, forming the edge 1004 between the non-adjacent control sets can provide for consistency among the remaining control sets from the narrow-view camera.

The example graphs 800, 900, and 1000 of FIGS. 8-10 each depict a configuration having per-device and per-sensor representations, where a representation is present (or otherwise accounted for) for each combination of traffic signal device and sensor. In some implementations, a simplified control node graph can be utilized by a traffic signal state detection system according to the present disclosure. For instance, one way to simplify a control node graph is to condense multiple representations for a single traffic signal device to a single representation per device. One approach is to process the multiple representations as a single “stacked” representation over multiple channels (e.g., a 3×3-channel image). Another approach includes maintaining separate input channels and pooling same-device representations using a technique such as max/mean pooling or a machine-learned pooling model (e.g., a network). For instance, representations from each data channel can be combined into a single aggregate vertex that includes or corresponds to the representations from each data channel. Fusing representations from the plurality of channels can provide for improved consistency of outputs as the autonomous vehicle navigates throughout the environment. For example, the output can be robust to changes in availability or priority of information from each channel. Furthermore, a single per-device representation can provide for fewer modifications to the graph over time (potentially providing improved learnability for the control node graph processing model), a smaller graph (e.g., requiring reduced computing resources to store, transmit, and/or process), and/or the capability to learn different features for each channel or group (e.g., providing beneficial recognition of different aspects of each channel, such as color variations between cameras, resolution differences, and so on). These aggregate vertices can naturally summarize the contributions of representations of different control node subgraphs. Furthermore, because the control node graph processing model operates end-to-end, it can be possible for the control node graph processing model to extract features from the control node graphs without providing labels for each representation.

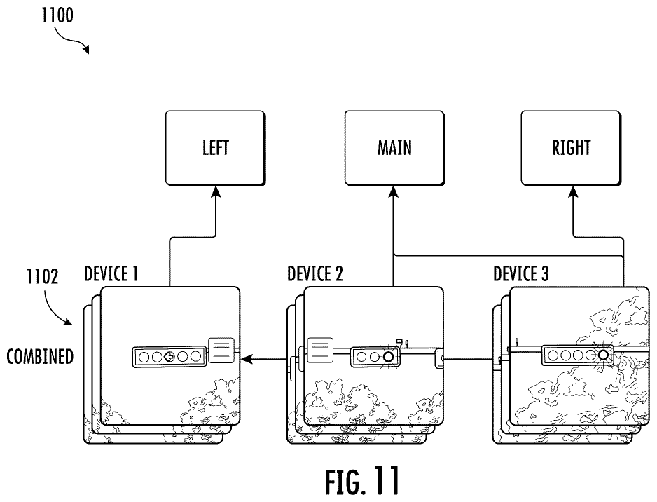

FIG. 11 depicts another example control node graph 1100 according to some implementations of the present disclosure. The graph 1100 includes three aggregate vertices 1102 corresponding to three unique subgraphs (e.g., control sets). More particularly, the aggregate vertices 1102 correspond to a left control set, a main control set, and a right control set. Each aggregate vertex 1102 can include one or more representations of a particular traffic signal device. For example, the aggregate vertex 1102 corresponding to the left control set can include a plurality of representations of a traffic signal device that signals authorization to perform a left turn. The plurality of representations can, for example, be captured from multiple data channels. In addition to and/or alternatively to representations from multiple data channels, in some implementations, the control node graph can include vertices corresponding to representations of a traffic signal device from a plurality of time instances. The plurality of time instances can capture some previous time instance(s) or time duration. For example, the plurality of time instances can capture a number of seconds prior to a current time instance. Additionally or alternatively, in some implementations, the plurality of time instances can include future time instances or time durations. For example, during training of the control node graph processing model, representations from the future time instance may be used as ground truth data. The control node graph can include vertices corresponding to representations of traffic signal devices from a second time instance or time duration. In some implementations, the control node graph can include edges connecting vertices corresponding to representations of traffic signal devices from the second time instance or time duration to corresponding representations of the traffic signal devices from a current time instance. The edges can indicate that the prior vertices and the current vertices are both respective to a common traffic signal device.

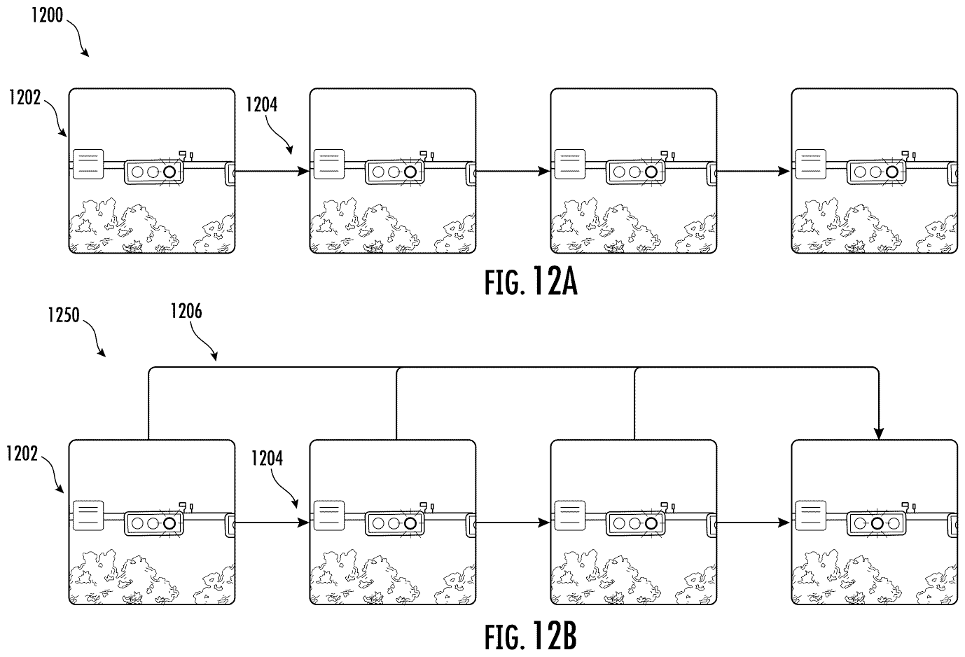

FIG. 12A depicts another example control node graph 1200 according to some implementations of the present disclosure. The control node graph 1200 includes representations 1202 from a plurality of time instances connected by directed edges 1204. The directed edges 1204 can flow from a first representation 1202 of a common traffic signal device at an earlier time instance to a second representation 1202 the same traffic signal device at a later time instance. Utilizing directed edges 1204 can provide for states at future time instances to not influence states at past time instances.

FIG. 12B depicts another example control node graph 1250 according to some implementations of the present disclosure. The graph 1250 can include a nonlinear progression of time such that directed edges 1206 couple each representation 1202 of a traffic signal device at prior time instances (e.g., over some duration of relevant prior time instances) to the representation 1202 of the traffic signal device at the current time instance. This can provide for the capability for the control node graph processing model to use several prior states to assist in the current prediction. This duration of time over which prior time instances are considered may be useful, for example, in detecting more transient traffic signal indications, such as flashing yellow or red lights, or a state transition of the traffic control node. In the example of FIG. 12B, each prior representation 1202 is coupled to a current representation by an edge 1206. In some implementations, however, only some of the prior representations 1202 can be coupled to the present representation according to specified time dilation (e.g., “skipping” over certain points in time).

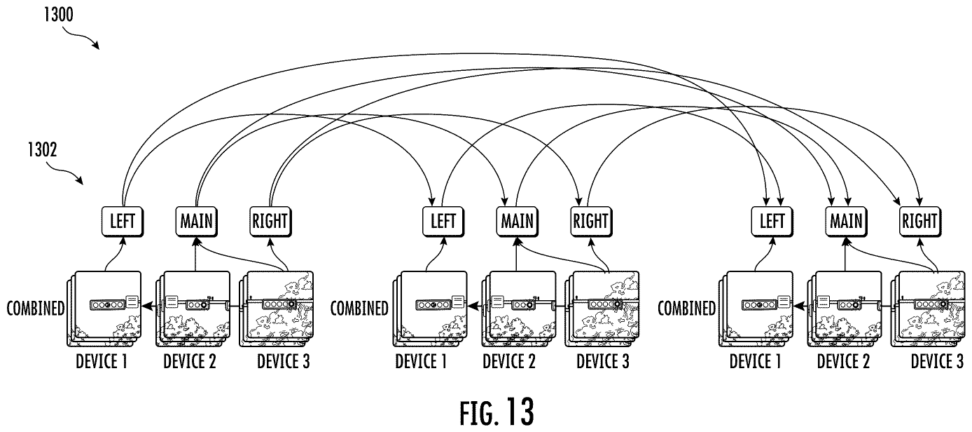

FIG. 13 depicts another example control node graph 1300 according to some implementations of the present disclosure. The control node graph 1300 includes spatiotemporally aggregated vertices 1302 that include both spatial aggregation across representations of common traffic signal devices (e.g., as discussed with respect to FIG. 11) and temporal aggregation across time instances (e.g., as discussed with respect to FIG. 12). The control node graph 1300 can beneficially leverage an ability of the control node graph processing model to determine (e.g., by attention) which portions of substantially an entire observed history of a traffic control node are relevant at each time instance (e.g., each observed frame of sensor data). In some cases, the out degree of the oldest frame can be H−1 where H is the number of frames in the observed history, and the in degree of the oldest frame can be 0. Symmetrically, the in degree of the newest frame can be H−1 and/or the out degree of the newest frame can be 0. This configuration can further provide for omitting an explicit graph-level aggregation step, since loss can be applied to classification MLPs at each aggregated control set node in the full control node history graph.

In this manner, the present disclosure can provide for implementing an incremental graph model that utilizes the ability of some models (e.g., graph neural networks, graph attention networks), to learn to process arbitrary graph sizes and configurations. One example implementation of the present disclosure is discussed below for the purposes of illustration only and not to limit the present disclosure. The input to the control node graph processing model can be a list of “control node bundles” where each bundle can include the following for an observable control node. The input can include Kᵢ current frame representations (Kᵢ×4×96×96) such that the model only sees the current frame representations. Previous frame representations can be passed forward to keep the per-frame image convolutions bounded. The input can additionally include an Nᵢ×C matrix that represents the historic Nᵢ node embeddings. Furthermore, the input can include an L×L adjacency matrix that represents the current control node history graph, including the aggregated control set nodes. L=Kᵢ+Nᵢ+3Hᵢ where Hᵢ is the current control node history at time i. Explicit edges can be used to support attention coefficients.

Given the separate graph inputs, the model can construct aggregate tensors for processing B current frame representations (e.g., for an arbitrary B such as B≥64) where

$$B = {\sum }_{j = 0}^{\vert ControlNodes \vert} {K}_{i}^{j} ;$$

an N′×C matrix that represents the historic node features; and/or a L′×L′ adjacency matrix describing the structure of all the graphs currently being processed. This can be a block diagonal matrix, where each block corresponds to the independent adjacency matrix for each active control node. Batch behavior can be utilized for the incoming B representations to node features. Furthermore, multiple graphs can be concurrently processed by encoding multiple disjoint graphs into a single adjacency matrix. This provides an incremental approach to constructing the adjacency matrix and may involve no batch-oriented processing operations for the graph convolutions.

The output of the control node graph processing model is a list of control node outputs including a (Kᵢ+Nᵢ)×C matrix of node features and a 3Hᵢ×S matrix of control set states (3 control set outputs with S features per historical graph) This output can provide that the model is fully stateless, since the current node features can be passed back into the model on the next frame. In addition, the full control set state output provides for flowing per-frame classification loss back through multiple routes through the graph.

In some implementations, a graph attention network can be utilized as the control node graph processing model. The graph attention network can utilize multi-head attention, represented as

$$\vec{{h}_{i}^{′}} = {\vert \vert}_{k = 1}^{K} σ ( {\sum }_{j ∈ N} , {α}_{ij}^{k} {W}^{k} {\vec{h}}_{j} )$$

where ∥ represents concatenation, the sigma is a non-linearity (e.g., as determined by an activation function such as but not limited to Leaky Rectified Linear Unit (LeakyReLU,) Exponential Linear Unit (ELU), Parametric Rectified Linear Unit (PreLU) etc.), the alphas are normalized attention coefficients, and the Ws are shared linear transformations of a vertex embedding h. These layers can be stacked to create a multi-layer graph neural network.

Example aspects of the present disclosure can provide a control node graph processing model that maintains batch oriented processing, so each device representation is independently processed in parallel, which can provide for omitting empty representations for intersections smaller than the maximum traffic control node size. Furthermore, the present disclosure can provide models that can additionally or alternatively scatter the computed device representations into a per-control node tensor which can provide for the model to learn about differently sized traffic control nodes. Furthermore, the present disclosure can provide models that can additionally or alternatively compute a per-control node embedding that effectively implements a combination of the graph structure and the simplification of per-device embedding with tagged traffic signal device control sets (e.g., compared to control-set-level aggregation). Furthermore, the present disclosure can provide models that can additionally or alternatively utilize control node embeddings aggregated over time as input to a temporal convolutional system to implement an efficient version of the temporal encoding described above. The model outputs the state history, and accepts that state history as input for the next iteration; this can provide for the model to be internally stateless. Furthermore, the present disclosure can provide end-to-end differentiability of the model, incorporating device representations, aggregated control node representations, and temporal history to produce a final current control node state estimate.

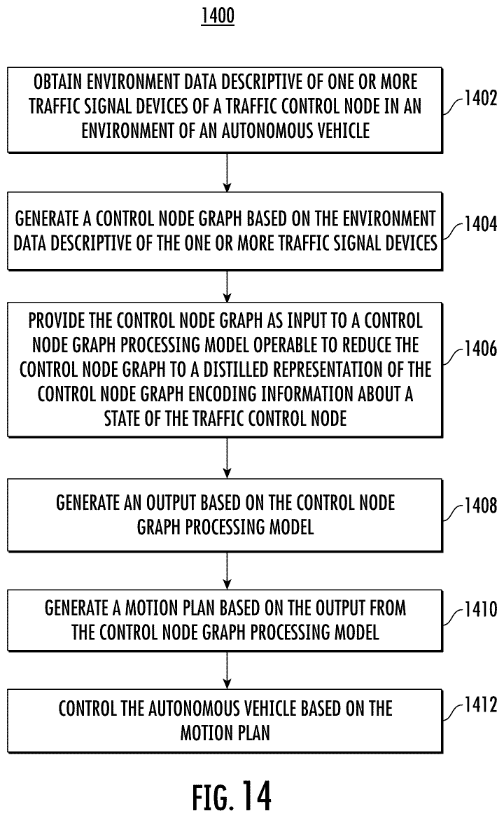

FIG. 14 is a flowchart of an example method 1400 according to some implementations of the present disclosure. One or more portion(s) of the described method 1400 may be implemented by a computing system that includes one or more computing devices such as, for example, the computing systems described with reference to the other figures (e.g., autonomous platform 110, onboard computing system 180, remote system(s) 160, a system of FIG. 4). Each respective portion of the method 1400 may be performed by any (or any combination) of one or more computing devices. Moreover, one or more portion(s) of the method 1400 may be implemented on the hardware components of the device(s) described herein (e.g., as in FIGS. 1, 2, 4), for example, for traffic signal state detection as described herein.

FIG. 14 depicts elements performed in a particular order for purposes of illustration and discussion. Those of ordinary skill in the art, using the disclosures provided herein, will understand that the elements of any of the methods discussed herein may be adapted, rearranged, expanded, omitted, combined, or modified in various ways without deviating from the scope of the present disclosure. FIG. 14 is described with reference to elements/terms described with respect to other systems and figures for exemplary illustrated purposes and is not meant to be limiting. One or more portions of the described methods may be performed additionally, or alternatively, by other systems.

At 1402, the method 1400 may include obtaining environment data descriptive of one or more traffic signal devices of a traffic control node in an environment of an autonomous vehicle. As described herein, the environment data may include sensor data captured through one or more sensors onboard an autonomous vehicle. This may include RADAR data, LIDAR data, image data, or other types of data. For example, the environment data may include image frames captured during instances of real-world driving, and associated times in which the objects in the environment were perceived. The environment data may include data collected from other sources (e.g. roadside cameras, aerial vehicles, other vehicles).

The environment data may be associated with a plurality of times. By way of example, the environment data may include a plurality of image frames indicative of or descriptive of a traffic signal device in an environment of the autonomous vehicle. Each respective image frame may be associated with a time/time stamp at which the image frame was captured. For instance, the plurality of image frames may include a sequence of image frames taken across a plurality of times and depicting an object in the environment. Furthermore, in some implementations, each respective image frame may be associated with a sensor (e.g., a camera) from which the image frame was obtained. For example, in some implementations, an autonomous vehicle may be provided with a plurality of cameras having varying aspects (e.g., field of view, resolution) and the environment data can include image frames from each of the plurality of cameras.

As described herein, the environment data may describe a traffic signal device within an environment of the autonomous vehicle. As used herein, a “traffic signal device” can refer to a device configured to indicate the authorized movement of vehicles, pedestrians, and/or other actors within an intersection or along a direction of travel. A traffic signal device may be, for example, a device otherwise referred to as a “traffic light,” “stoplight,” “pedestrian hybrid beacon” or “PHB”, “high-intensity activated crosswalk beacon” or “HAWK beacon”, or other suitable indicator device. The traffic signal device may generally follow an understood convention for signaling the authorized flow of traffic. For example, the traffic signal device may include one or more bulb elements that are selectively lit to indicate whether actors are authorized to proceed or not. The colors, shapes, patterns, and/or arrangement of the bulb elements can convey information relating to the authorized movement of actors (e.g., vehicles, pedestrians) within an area controlled by the traffic signal device. The area controlled by the traffic signal device can be or can include, for example, a vehicle lane, a bicycle lane, a pedestrian walkway or sidewalk, a crosswalk, an intersection, a drawbridge, or other feature providing for the selective allowance or disallowance of passage through the area. The environment may be, for example, the environment outside of and surrounding the autonomous vehicle (e.g., within a sensor field of view). In some implementations, the environment data may include video data. Additionally, or alternatively, the environment data may include multiple single, static images.

At 1404, the method 1400 may include generating a control node graph based on the environment data descriptive of the one or more traffic signal devices. The control node graph can include vertices respective to representations of the traffic signal devices in the data and edges indicative of relationships between the representations of the traffic signal devices in the environment data descriptive of the one or more traffic signal devices. The computing system can generate a control node graph that represents the traffic control node based on environment data depicting the traffic control node. For instance, the control node graph can include vertices corresponding to one or more representations of each traffic signal device of the traffic control node in the environment data and/or edges between the vertices defining relationships between the representations. For example, in some implementations, an edge between a first vertex and a second vertex can indicate that the first vertex and the second vertex share a same scene or a same time instance, depict a common traffic signal device, depict adjacent traffic signal devices, or otherwise share some relationship.

The representations of traffic signal devices in the environment data can be any suitable representation. As one example, in some implementations, the representations of traffic signal devices can be environment data within portions of a larger set of initial environment data associated with the traffic signal devices. For example, in some implementations, a perception system or perception model can receive initial environment data. For instance, the initial environment data can be or can include a scan or sweep of a field of view of a sensor device, a stored scan or image, or other relatively larger data that depicts the traffic signal devices and may depict other elements that are not the traffic signal devices. The perception system can generate RoI data associated with each traffic signal device in the initial environment data. The RoI data can include, for example, coordinates, bounding boxes, or other information that is descriptive of a portion of the initial environment data respectively associated with a traffic signal device. The perception system or another system can extract the environment data within the portions of the initial environment data respectively associated with the one or more traffic signal devices from the initial environment data based on the data descriptive of the portions of the initial environment data. For example, if the initial environment data is a scan, sweep, or image, extracting the environment data can include cropping the scan, sweep, or image to include only data bounded by or within the region of interest.

As another example, in some implementations, the representations of traffic signal devices in the environment can be or can include a transformed or distilled representation of the environment data corresponding to the traffic signal devices. For example, in some implementations, the environment data corresponding to a particular traffic signal device may be extracted for a region of interest as described above. The extracted environment data can be used to generate a distilled representation of the environment data corresponding to the particular traffic signal device. As one example, the distilled representation can be an embedding. For instance, the control node graph processing model or another suitable model can process the extracted environment data for a region of interest corresponding to a particular traffic signal device and output the distilled representation of the extracted environment data within the region of interest.

Representations from multiple data channels (e.g., corresponding to multiple sensor devices or data sources) can be used to produce multiple vertices and/or an aggregate vertex for a traffic signal device. For example, in some implementations, an autonomous vehicle can include a plurality of sensor devices (e.g., cameras), where each sensor device can produce representations of a common traffic signal device in channels of environment data (e.g., sensor device data) from each sensor device. The representations can each correspond to a vertex in the control node graph, and may be grouped by edges indicating that the representations depict a common traffic signal device. As another example, in some implementations, the representations from each data channel can be combined into a single aggregate vertex that includes or corresponds to the representations from each data channel. Fusing representations from the plurality of channels can provide for improved consistency of outputs as the autonomous vehicle navigates throughout the environment. For example, the output can be robust to changes in availability or priority of information from each channel.

As one example, an autonomous vehicle can include a plurality of cameras having varying resolutions to capture image data of the environment of the autonomous vehicle from differing perspectives. For example, the autonomous vehicle may include a wide-angle camera configured to capture image data of a larger portion of the environment of the autonomous vehicle and a focused-view camera configured to capture image data of a relatively smaller portion of the environment of the autonomous vehicle.

Because of variations in positions of the cameras about the autonomous vehicle, each camera may be able to provide slightly different information about a particular region in the environment. For example, if the environment data corresponding to a traffic signal device in one camera is occluded by an object (e.g., foliage), another camera may have a view of the traffic signal device. As another example, as the autonomous vehicle approaches an intersection, the focused-view camera may have a view of a first traffic signal device (e.g., ahead of the autonomous vehicle), but may be unable to capture image data of a second traffic signal device in the intersection (e.g., in an adjacent lane, such as a turn lane), whereas the wide-angle camera may be able to capture image data of the second traffic signal device even when close to the intersection. By including representations of the traffic signal devices from the multiple cameras described above in a control node graph, the computing system can obtain an improved understanding of the environment of the autonomous vehicle and/or can provide improved scene consistency as an autonomous vehicle navigates throughout the environment. For example, the computing system can reason about the second traffic signal device even when it is occluded in one of the cameras. Furthermore, the output from the control node graph processing model can be consistent as traffic signal devices come into and out of view of the multiple cameras.

In addition to and/or alternatively to representations from multiple data channels, the control node graph can include vertices corresponding to representations of a traffic signal device from a plurality of time instances. The plurality of time instances can capture some previous time instance(s) or time duration. For example, the plurality of time instances can capture a number of seconds prior to a current time instance. Additionally or alternatively, in some implementations, the plurality of time instances can include future time instances or time durations. For example, during training of the control node graph processing model, representations from the future time instance may be used as ground truth data. The control node graph can include vertices corresponding to representations of traffic signal devices from a second time instance or time duration. In some implementations, the control node graph can include edges connecting vertices corresponding to representations of traffic signal devices from the second time instance or time duration to corresponding representations of the traffic signal devices from a current time instance. The edges can indicate that the prior vertices and the current vertices are both respective to a common traffic signal device.

At 1406, the method 1400 may include providing the control node graph as input to a control node graph processing model operable to reduce the control node graph to a distilled representation of the control node graph encoding information about a state of the traffic control node. In particular, the control node graph processing model can be configured to reduce the control node graph to a distilled representation of the control node graph. The distilled representation of the control node graph can be a relatively smaller amount of data than the control node graph. Furthermore, the distilled representation can encode information about a state of the traffic control node. For example, the control node graph processing model can be operable to extract relevant state information from the control node graph and generate an output that encodes that state information in a data-efficient manner. As one example, the distilled representation of the control node graph can be an embedding of the control node graph. In some implementations, the control node graph embedding can have a plurality of values that convey information about the state information. Additionally or alternatively, in some implementations, the distilled representation of the control node graph may be a one-hot embedding of the control node graph, where the hot value represents the present state of the traffic control node.

At 1408, the method 1400 may include, based on receipt of the control node graph as input, generating an output based on the control node graph processing model. In some implementations, the output of the control node graph processing model can be the distilled representation of the control node graph. Additionally or alternatively, in some implementations, the output of the control node graph processing model can be based on the distilled representation of the control node graph. For instance, the control node graph processing model can include a first mechanism that is operable to generate the distilled representation of the control node graph based on receipt of the control node graph as input. Additionally or alternatively, the control node graph processing model can include a second mechanism that is operable to convert the distilled representation of the control node graph to state data indicative of a state of the traffic control node. For example, some downstream systems of an autonomous vehicle computing system can utilize the state data as output of the control node graph processing model, but may not necessarily be capable of meaningfully processing the distilled representation of the control node graph. The first mechanism and/or the second mechanism can be any suitable mechanism or portion of the control node graph processing model. As examples, the first mechanism and/or the second mechanism can include one or more layers of the control node graph processing model, a submodel of the control node graph processing model, a pipeline or data stream within the control node graph processing model, or any other suitable mechanism. For instance, in some implementations, the first mechanism includes a plurality of first layers configured to reduce the control node graph to the distilled representation of the control node graph and the second mechanism includes a plurality of second layers configured to build the state data based on the distilled representation of the control node graph. As another example, in some implementations, the second mechanism can be or can include an attention mechanism configured to operate on neighboring vertices to extract relevant data during processing of the first mechanism.

At 1410, the method 1400 may include generating a motion plan based on the output from the control node graph processing model. For instance, a motion plan may include one or more trajectories (e.g., motion trajectories) that indicate a path for an autonomous platform to follow. A trajectory may be of a certain length or time range. The length or time range may be defined by the planning system. A motion trajectory may be defined by one or more waypoints (with associated coordinates). The waypoint(s) may be future location(s) for the autonomous platform. The motion plans may be continuously generated, updated, and considered by the planning system.

At 1412, the method 1400 may include controlling the autonomous vehicle based on the motion plan. For example, the autonomous vehicle (e.g., a control system 260) may translate a motion plan into instructions for the appropriate platform control devices (e.g., acceleration control, brake control, steering control). By way of example, the control system may translate a selected motion plan into instructions to adjust a steering component (e.g., a steering angle) by a certain number of degrees, apply a certain magnitude of braking force, increase/decrease speed, or implement other motion controls. In some implementations, the system may communicate with the platform control devices through communication channels including, for example, one or more data buses (e.g., controller area network (CAN)), onboard diagnostics connectors (e.g., OBD-II), or a combination of wired or wireless communication links. The platform control devices may send or obtain data, messages, signals (or other types of communication) to or from the autonomy system (or vice versa) through the communication channel(s).

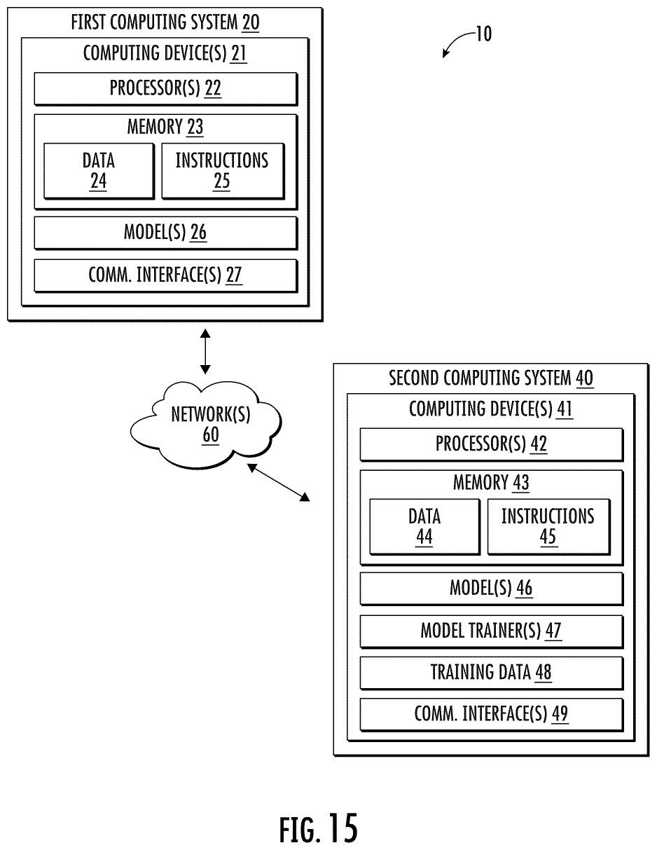

FIG. 15 is a block diagram of an example computing ecosystem 12 according to example implementations of the present disclosure. The example computing ecosystem 12 may include a first computing system 20 and a second computing system 40 that are communicatively coupled over one or more networks 60. In some implementations, the first computing system 20 or the second computing system 40 may implement one or more of the systems, operations, or functionalities described herein for validating one or more systems or operational systems (e.g., the remote system(s) 160, the onboard computing system(s) 180, the autonomy system(s) 200).

In some implementations, the first computing system 20 may be included in an autonomous platform and be utilized to perform the functions of an autonomous platform as described herein. For example, the first computing system 20 may be located onboard an autonomous vehicle and implement autonomy system(s) for autonomously operating the autonomous vehicle. In some implementations, the first computing system 20 may represent the entire onboard computing system or a portion thereof (e.g., the localization system 230, the perception system 240, the planning system 250, the control system 260, or a combination thereof). In other implementations, the first computing system 20 may not be located onboard an autonomous platform. The first computing system 20 may include one or more distinct physical computing devices 21.

The first computing system 20 (e.g., the computing device(s) 21 thereof) may include one or more processors 22 and a memory 23. The one or more processors 22 may be any suitable processing device (e.g., a processor core, a microprocessor, an ASIC, a FPGA, a controller, a microcontroller) and may be one processor or a plurality of processors that are operatively connected. The memory 23 may include one or more non-transitory computer-readable storage media, such as RAM, ROM, EEPROM, EPROM, one or more memory devices, flash memory devices, or combinations thereof.

The memory 23 may store information that may be accessed by the one or more processors 22. For instance, the memory 23 (e.g., one or more non-transitory computer-readable storage media, memory devices) may store data 24 that may be obtained (e.g., received, accessed, written, manipulated, created, generated, stored, pulled, downloaded). The data 24 may include, for instance, sensor data, map data, data associated with autonomy functions (e.g., data associated with the perception, planning, or control functions), simulation data, or any data or information described herein. In some implementations, the first computing system 20 may obtain data from one or more memory device(s) that are remote from the first computing system 20.

The memory 23 may store computer-readable instructions 25 that may be executed by the one or more processors 22. The instructions 25 may be software written in any suitable programming language or may be implemented in hardware. Additionally, or alternatively, the instructions 25 may be executed in logically or virtually separate threads on the processor(s) 22.

For example, the memory 23 may store instructions 25 that are executable by one or more processors (e.g., by the one or more processors 22, by one or more other processors) to perform (e.g., with the computing device(s) 21, the first computing system 20, or other system(s) having processors executing the instructions) any of the operations, functions, or methods/processes (or portions thereof) described herein. For example, operations may include implementing system validation (e.g., as described herein).

In some implementations, the first computing system 20 may store or include one or more models 26. In some implementations, the models 26 may be or may otherwise include one or more machine-learned models (e.g., a machine-learned shape detection model). As examples, the models 26 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the first computing system 20 may include one or more models for implementing subsystems of the autonomy system(s) 200, including any of: the localization system 230, the perception system 240, the planning system 250, or the control system 260.

In some implementations, the first computing system 20 may obtain the one or more models 26 using communication interface(s) 27 to communicate with the second computing system 40 over the network(s) 60. For instance, the first computing system 20 may store the model(s) 26 (e.g., one or more machine-learned models) in the memory 23. The first computing system 20 may then use or otherwise implement the models 26 (e.g., by the processors 22). By way of example, the first computing system 20 may implement the model(s) 26 to localize an autonomous platform in an environment, perceive an autonomous platform's environment or objects therein, plan one or more future states of an autonomous platform for moving through an environment, control an autonomous platform for interacting with an environment, perform the techniques and processes described herein, or perform other functions.

The second computing system 40 may include one or more computing devices 41. The second computing system 40 may include one or more processors 42 and a memory 43. The one or more processors 42 may be any suitable processing device (e.g., a processor core, a microprocessor, an ASIC, a FPGA, a controller, a microcontroller) and may be one processor or a plurality of processors that are operatively connected. The memory 43 may include one or more non-transitory computer-readable storage media, such as RAM, ROM, EEPROM, EPROM, one or more memory devices, flash memory devices, and combinations thereof.

The memory 43 may store information that may be accessed by the one or more processors 42. For instance, the memory 43 (e.g., one or more non-transitory computer-readable storage media, memory devices) may store data 44 that may be obtained. The data 44 may include, for instance, sensor data, model parameters, map data, simulation data, simulated environmental scenes, simulated sensor data, data associated with vehicle trips/services, or any data or information described herein. In some implementations, the second computing system 40 may obtain data from one or more memory devices that are remote from the second computing system 40.

The memory 43 may also store computer-readable instructions 45 that may be executed by the one or more processors 42. The instructions 45 may be software written in any suitable programming language or may be implemented in hardware. Additionally, or alternatively, the instructions 45 may be executed in logically or virtually separate threads on the processors 42.

For example, the memory 43 may store instructions 45 that are executable (e.g., by the one or more processors 42, by the one or more processors 22, by one or more other processors) to perform (e.g., with the computing devices 41, the second computing system 40, or other system(s) having processors for executing the instructions, such as computing devices 21 or the first computing system 20) any of the operations, functions, or methods/processes described herein. This may include, for example, the functionality of the autonomy system(s) 200 (e.g., localization, perception, planning, control) or other functionality associated with an autonomous platform (e.g., remote assistance, mapping, fleet management, trip/service assignment and matching). This may also include, for example, validating a machined-learned operational system.

In some implementations, the second computing system 40 may include one or more server computing devices. In the event that the second computing system 40 includes multiple server computing devices, such server computing devices may operate according to various computing architectures, including, for example, sequential computing architectures, parallel computing architectures, or some combination thereof.

Additionally, or alternatively to, the model(s) 26 at the first computing system 20, the second computing system 40 may include one or more models 46. As examples, the model(s) 46 may be or may otherwise include various machine-learned models (e.g., a machine-learned shape detection model) such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the second computing system 40 may include one or more models of the autonomy system(s) 200.

In some implementations, the second computing system 40 or the first computing system 20 may train one or more machine-learned models of the model(s) 26 or the model(s) 46 through the use of one or more model trainers 47 and training data 48. The model trainer(s) 47 may train any one of the model(s) 26 or the model(s) 46 using one or more training or learning algorithms. One example training technique is backwards propagation of errors. In some implementations, the model trainer(s) 47 may perform supervised training techniques using labeled training data. In other implementations, the model trainer(s) 47 may perform unsupervised training techniques using unlabeled training data. In some implementations, the training data 48 may include simulated training data (e.g., training data obtained from simulated scenarios, inputs, configurations, environments). In some implementations, the second computing system 40 may implement simulations for obtaining the training data 48 or for implementing the model trainer(s) 47 for training or testing the model(s) 26 or the model(s) 46. By way of example, the model trainer(s) 47 may train one or more components of a machine-learned model for the autonomy system(s) 200 through unsupervised training techniques using an objective function (e.g., costs, rewards, heuristics, constraints). In some implementations, the model trainer(s) 47 may perform a number of generalization techniques to improve the generalization capability of the model(s) being trained. Generalization techniques include weight decays, dropouts, or other techniques.

For example, in some implementations, the second computing system 40 may generate training data 48 according to example aspects of the present disclosure. For instance, the second computing system 40 may generate training data 48. For instance, the second computing system 40 may implement methods according to example aspects of the present disclosure. The second computing system 40 may use the training data 48 to train model(s) 26. For example, in some implementations, the first computing system 20 may include a computing system onboard or otherwise associated with a real or simulated autonomous vehicle. In some implementations, model(s) 26 may include perception or machine vision model(s) configured for deployment onboard or in service of a real or simulated autonomous vehicle. In this manner, for instance, the second computing system 40 may provide a training pipeline for training model(s) 26.

The first computing system 20 and the second computing system 40 may each include communication interfaces 27 and 49, respectively. The communication interfaces 27, 49 may be used to communicate with each other or one or more other systems or devices, including systems or devices that are remotely located from the first computing system 20 or the second computing system 40. The communication interfaces 27, 49 may include any circuits, components, software, or other components for communicating with one or more networks (e.g., the network(s) 60). In some implementations, the communication interfaces 27, 49 may include, for example, one or more of a communications controller, receiver, transceiver, transmitter, port, conductors, software or hardware for communicating data.

The network(s) 60 may be any type of network or combination of networks that allows for communication between devices. In some implementations, the network(s) may include one or more of a local area network, wide area network, the Internet, secure network, cellular network, mesh network, peer-to-peer communication link or some combination thereof and may include any number of wired or wireless links. Communication over the network(s) 60 may be accomplished, for instance, through a network interface using any type of protocol, protection scheme, encoding, format, packaging, or combination thereof.

FIG. 15 illustrates one example computing ecosystem 10 that may be used to implement the present disclosure. Other systems may be used as well. For example, in some implementations, the first computing system 20 may include the model trainer(s) 47 and the training data 48. In such implementations, the model(s) 26, 46 may be both trained and used locally at the first computing system 20. As another example, in some implementations, the first computing system 20 may not be connected to other computing systems. Additionally, components illustrated or discussed as being included in one of the computing systems 20 or 40 may instead be included in another one of the computing systems 20 or 40.

Computing tasks discussed herein as being performed at computing device(s) remote from the autonomous platform (e.g., autonomous vehicle) may instead be performed at the autonomous platform (e.g., via a vehicle computing system of the autonomous vehicle), or vice versa. Such configurations may be implemented without deviating from the scope of the present disclosure. The use of computer-based systems allows for a great variety of possible configurations, combinations, and divisions of tasks and functionality between and among components. Computer-implemented operations may be performed on a single component or across multiple components. Computer-implemented tasks or operations may be performed sequentially or in parallel. Data and instructions may be stored in a single memory device or across multiple memory devices.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but”. It should be understood that such conjunctions are provided for explanatory purposes only. Lists joined by a particular conjunction such as “or,” for example, may refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein may be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. may be used to illustrate operations. Such identifiers are provided for the ease of the reader and do not denote a particular order of steps or operations. An operation illustrated by a list identifier of (a), (i), etc. may be performed before, after, or in parallel with another operation illustrated by a list identifier of (b), (ii), etc.

What is claimed is:

1. A computer-implemented method, comprising:
obtaining environment data descriptive of one or more traffic signal devices of a traffic control node in an environment of an autonomous vehicle;
generating a control node graph based on the environment data descriptive of the one or more traffic signal devices, the control node graph comprising vertices respective to representations of the traffic signal devices in the environment data and edges indicative of relationships between the representations of the traffic signal devices in the environment data descriptive of the one or more traffic signal devices;
providing the control node graph as input to a control node graph processing model operable to reduce the control node graph to a distilled representation of the control node graph encoding information about a state of the traffic control node;
based on receipt of the control node graph as input, generating an output based on the control node graph processing model;
generating a motion plan based on the output from the control node graph processing model; and
controlling the autonomous vehicle based on the motion plan.

2. The computer-implemented method of claim 1, comprising obtaining the environment data descriptive of the one or more traffic signal devices from a first data channel and a second data channel.

3. The computer-implemented method of claim 2, comprising:
generating a first vertex of the control node graph corresponding to a first representation of a first traffic signal device in the environment data from the first data channel; and
generating a second vertex of the control node graph corresponding to a second representation of the first traffic signal device in the environment data from the second data channel.

4. The computer-implemented method of claim 3, comprising generating an edge of the control node graph, the edge indicating that the first vertex and the second vertex are both respective to a first traffic signal device.

5. The computer-implemented method of claim 2, comprising generating a first vertex of the control node graph, the first vertex common to both a first representation of a first traffic signal device in the environment data from the first data channel and a second representation of the first traffic signal device in the environment data from the second data channel.

6. The computer-implemented method of claim 2, comprising:
obtaining the environment data from a first sensor device over the first data channel; and
obtaining the environment data from a second sensor device over the second data channel.

7. The computer-implemented method of claim 6, wherein the first sensor device comprises a first camera having a first field of view and the second sensor device comprises a second camera having a second field of view, the first field of view being different from the second field of view.

8. The computer-implemented method of claim 1, comprising:
generating, by a first mechanism of the control node graph processing model, the distilled representation of the control node graph based on receipt of the control node graph as input; and
generating, by a second mechanism of the control node graph processing model, the output from the control node graph, wherein the output comprises state data indicative of the state of the traffic control node.

9. The computer-implemented method of claim 1, comprising:
generating a first vertex of the control node graph associated with a first traffic signal device at a first time instance; and
generating a second vertex of the control node graph associated with the first traffic signal device at a second time instance, the second time instance being different from the first time instance.

10. The computer-implemented method of claim 9, comprising generating an edge between the first vertex and the second vertex, the edge indicating that the first vertex and the second vertex are both respective to a first traffic signal device.

11. The computer-implemented method of claim 9, wherein the control node graph is a first control node graph, the method comprising:
providing a distilled representation of a second control node graph respective to the second time instance as input to the control node graph processing model to generate the distilled representation of the first control node graph;
wherein the distilled representation of the first control node graph is associated with the first time instance.

12. The computer-implemented method of claim 1, wherein the control node graph processing model comprises at least one of a graph neural network (GNN), graph attention network (GAT), or a graph convolutional network (GCN), the control node graph processing model trained end-to-end to enable the control node graph processing model to reduce the control node graph to the distilled representation of the control node graph encoding information about the state of the traffic control node.

13. The computer-implemented method of claim 1, wherein the environment data descriptive of one or more traffic signal devices comprises portions of the environment data respectively associated with the one or more traffic signal devices.

14. The computer-implemented method of claim 13, further comprising:
obtaining initial environment data descriptive of a field of view within the environment of the autonomous vehicle;
generating, by a perception system, data descriptive of the portions of the initial environment data respectively associated with the one or more traffic signal devices; and
extracting the environment data within the portions of the initial environment data respectively associated with the one or more traffic signal devices from the initial environment data based on the data descriptive of the portions of the initial environment data.

15. An autonomous vehicle (AV) computing system, the AV computing system comprising:
one or more processors; and
one or more non-transitory, computer-readable media storing instructions that, when implemented, cause the one or more processors to perform operations, the operations comprising:
obtaining environment data descriptive of one or more traffic signal devices of a traffic control node in an environment of an autonomous vehicle;
generating a control node graph based on the environment data descriptive of the one or more traffic signal devices, the control node graph comprising vertices respective to representations of the traffic signal devices in the environment data and edges indicative of relationships between the representations of the traffic signal devices in the environment data descriptive of the one or more traffic signal devices;
providing the control node graph as input to a control node graph processing model operable to reduce the control node graph to a distilled representation of the control node graph encoding information about a state of the traffic control node;
based on receipt of the control node graph as input, generating an output based on the control node graph processing model;
generating a motion plan based on the output from the control node graph processing model; and
controlling the autonomous vehicle based on the motion plan.

16. The AV computing system of claim 15, wherein the operations comprise obtaining the environment data descriptive of the one or more traffic signal devices from a first data channel and a second data channel.

17. The AV computing system of claim 16, wherein the operations comprise:
generating a first vertex of the control node graph corresponding to a first representation of a first traffic signal device in the environment data from the first data channel; and
generating a second vertex of the control node graph corresponding to a second representation of the first traffic signal device in the environment data from the second data channel.

18. The AV computing system of claim 17, wherein the operations comprise generating an edge of the control node graph, the edge indicating that the first vertex and the second vertex are both respective to a first traffic signal device.

19. The AV computing system of claim 16, comprising generating a first vertex of the control node graph, the first vertex common to both a first representation of a first traffic signal device in the environment data from the first data channel and a second representation of the first traffic signal device in the environment data from the second data channel.

20. An autonomous vehicle comprising:
one or more processors; and
one or more non-transitory, computer-readable media storing instructions that, when implemented, cause the one or more processors to perform operations, the operations comprising:
obtaining environment data descriptive of one or more traffic signal devices of a traffic control node in an environment of an autonomous vehicle;
generating a control node graph based on the environment data descriptive of the one or more traffic signal devices, the control node graph comprising vertices respective to representations of the traffic signal devices in the environment data and edges indicative of relationships between the representations of the traffic signal devices in the environment data descriptive of the one or more traffic signal devices;
providing the control node graph as input to a control node graph processing model operable to reduce the control node graph to a distilled representation of the control node graph encoding information about a state of the traffic control node;
based on receipt of the control node graph as input, generating an output based on the control node graph processing model;
generating a motion plan based on the output from the control node graph processing model; and
controlling the autonomous vehicle based on the motion plan.
